(19) United States
(12) Patent Application Publication
(10) Pub. No.: US 2012/0050468 A1
(43) Pub. Date: Mar. 1, 2012

(54) DISPLAY CONTROL DEVICE, DISPLAY CONTROL METHOD, IMAGE GENERATION DEVICE, AND IMAGE GENERATION METHOD

(75) Inventors: Yoshitomo Takahashi, Kanagawa (JP); Teruhiko Suzuki, Kanagawa (JP); Takuya Kitamura, Tokyo (JP)

(73) Assignee: Sony Corporation, Tokyo (JP)

(21) Appl. No.: 13/212,407

(22) Filed: Aug. 18, 2011

(30) Foreign Application Priority Data
Aug. 25, 2010 (JP) 2010-187822

(51) Int. Cl. H04N 13/04; H04N 13/00

(52) U.S. Cl. 348/43; 348/56; 348/E13.075; 348/E13.021

(57) ABSTRACT

A display control device includes a separation unit that separates a multiplex image into a left eye image after decimation and a right eye image after decimation, interpolates a predetermined phase of the left eye image after the decimation with 0, and interpolates a phase reverse to the predetermined phase of the right eye image after the decimation with 0, a display control unit that uses an interpolated left eye image as a left eye display image, uses an interpolated right eye image as a right eye display image, and alternately displays the left eye display image and the right eye display image, and a glasses control unit that controls glasses such that a left eye shutter and a right eye shutter of the glasses are both opened, in a case where an image including the left eye image and the right eye image is a 2D image.

### BACKGROUND

The present disclosure relates to a display control device, a display control method, an image generation device, and an image generation method, and more particularly to a display control device, a display control method, an image generation device, and an image generation method, capable of further improving image quality of a 2D image for the left eye and a 2D image for the right eye after being restored in a case where the 2D image for the left eye and the 2D image for the right eye are multiplexed by decimating phases reverse to each other.

In recent years, viewing 3D images has been a discussion topic, and various processing methods of 3D images have been proposed. For example, as an encoding method and a decoding method of 3D images, a method for multi-view images has been proposed (for example, refer to Japanese Unexamined Patent Application Publication No. 2008-182669).

In addition, a method has also been proposed in which a left eye image and a right eye image forming a 3D image are multiplexed into an HD (High Definition) image of one frame. As multiplexing methods, there are a side by side method in which a left eye image and a right eye image forming a 3D image are divided and disposed at the left side and the right side of an image plane, an over and under method in which a left eye image and a right eye image are divided and disposed at the upper side and the lower side of the image plane, and the like.

When 3D images are multiplexed into an HD image of one frame, the 3D images can be transmitted or accumulated at a video rate which is the same as 2D images. Since an encoding method can use the existing AVC (Advanced Video Coding) method, the MPEG2 (Moving Picture Experts Group phase 2) method, or the like in a manner similar to 2D images, the 3D images can be handled with existing encoding devices or decoding devices.

One video stream is formed by 3D images and 2D images in some cases. For example, there are cases where, in a video stream for broadcasting, images created in 3D, and commercial images in 2D are mixed, or, in a video stream for movies, scenes of 3D images and scenes of 2D images are mixed according to an intention of a creator.

FIG. 1 is a block diagram illustrating an example of a configuration of an image process system in the related art, which encodes one video stream in which 2D images and 3D images are mixed and decodes the encoded images.

The image processing system 1 in FIG. 1 includes an encoding device 11 and a decoding device 12. The encoding device 11 has an image multiplexing unit 21 and an image encoding unit 22.

One video stream including 2D images and 3D images is input to the image multiplexing unit 21 of the encoding device 11, and the image multiplexing unit 21 obtains the 2D images and the 3D images as input images. In addition, the 2D images are formed by left eye images and right eye images having the same viewpoint, and the 3D images are formed by left eye images and right eye images having different viewpoints.

The image multiplexing unit 21 performs a multiplexing process of multiplexing the input images by the side by side method. Specifically, the image multiplexing unit 21 performs a low pass filter process for the input images such that the bandwidth of the input images is decreased by half. The image multiplexing unit 21 extracts pixels located at even numbered positions in the horizontal direction in the left eye images of the input images having undergone the low pass filter process so as to reduce the left eye images by half, and designates the reduced images as images of left half regions of multiplex images. In addition, the image multiplexing unit 21 extracts pixels located at odd numbered positions in the horizontal direction in the right eye images obtained as a result of the low pass filter process so as to reduce the right eye images by half, and designates the reduced images as images of right half regions of the multiplex images. Further, the image multiplexing unit 21 supplies the multiplex images, which are obtained as a result of the multiplexing process and have the same size as the input images, to the image encoding unit 22.

The image encoding unit 22 encodes the multiplex images supplied from the image multiplexing unit 21 by an encoding method such as AVC, and supplies encoded streams obtained as a result thereof to the decoding device 12.

The decoding device 12 includes an image decoding unit 31, an image separation unit 32, a frame sequence display control unit 33, and a 3D glasses control unit 34.

The image decoding unit 31 of the decoding device 12 decodes the encoded streams supplied from the image encoding unit 22 by a method corresponding to the encoding method in the image encoding unit 22, and supplies multiplex images obtained as a result thereof to the image separation unit 32.

The image separation unit 32 performs a separation process of separating each of the multiplex images supplied from the image decoding unit 31 into left and right half regions. Specifically, the image separation unit 32 designates the respective pixels of the left half region of the multiplex image as pixels located at the even numbered positions in the horizontal direction, and interpolates pixels located at the odd numbered positions in the horizontal direction with 0, thereby generating an image having the same size as the input image. In addition, the image separation unit 32 performs the low pass filter process for the generated image so as to decrease the bandwidth of the image to a half of the input image. The image separation unit 32 supplies an image obtained as a result of the low pass filter process to the frame sequence display control unit 33 as a left eye display image.

The image separation unit 32 designates the respective pixels of the right half region of the multiplex image as pixels located at the odd numbered positions in the horizontal direction, and interpolates pixels located at the even numbered positions in the horizontal direction with 0, thereby generating an image having the same size as the input image. In addition, the image separation unit 32 performs the low pass filter process for the generated image so as to decrease the bandwidth of the image to a half of the input images. The image separation unit 32 supplies the image obtained as a result of the low pass filter process to the frame sequence display control unit 33 as a right eye display image.

The frame sequence display control unit 33 (display control means) alternately displays the left eye display image and the right eye display image supplied from the image separation unit 32 on a display device (not shown). In addition, the frame sequence display control unit 33 supplies display information indicating whether a display target is a left eye display image or a right eye display image, to the 3D glasses control unit 34.

The 3D glasses control unit 34 (glasses control means) controls 3D glasses based on the display information supplied from the frame sequence display control unit 33 such that a left eye shutter (not shown) of the 3D glasses is opened when the left eye display image is displayed, and a right eye shutter thereof is opened when the right eye display image is displayed. Thereby, a user wearing the 3D glasses can view the left eye display image displayed on the display device (not shown) only with the left eye and can view the right eye display image only with the right eye. As a result, in a case where the right eye display image and the left eye display image have different viewpoints, the user can view 3D images, and in a case where the right eye display image and the left eye display image have the same viewpoint, the user can view 2D images.

As described above, the image multiplexing unit 21 performs the low pass filter process before the decimation, and thus it is possible to prevent aliasing caused by the reduction. In addition, the image separation unit 32 performs the low pass filter process for the image after the interpolation, and thus it is possible to remove an imaging component caused by the interpolation.

### SUMMARY

However, by the low pass filter process, the bandwidth of the image after the process is decreased to a half of the bandwidth before the process, and thus the bandwidth of the 2D image displayed on the display device (not shown) is decreased to a half of the bandwidth of the input image. The display resolution of the 2D image displayed on the display device (not shown) is decreased to a half of the display resolution of the input image.

It is desirable to further improve image quality of a 2D image for the left eye and a 2D image for the right eye after being restored in a case where the 2D image for the left eye and the 2D image for the right eye are multiplexed by decimating phases reverse to each other.

According to a first embodiment of the present disclosure, there is provided a display control device including a separation unit that separates a multiplex image obtained by multiplexing a left eye image after decimation of a predetermined phase and a right eye image after decimation of a phase reverse to the predetermined phase, into the left eye image after the decimation and the right eye image after the decimation, interpolates the predetermined phase of the left eye image after the decimation with 0, and interpolates the phase reverse to the predetermined phase of the right eye image after the decimation with 0; a display control unit that uses an interpolated left eye image obtained by interpolating the left eye image after the decimation as a left eye display image, uses an interpolated right eye image obtained by interpolating the right eye image after the decimation as a right eye display image, and alternately displays the left eye display image and the right eye display image, in a case where an image including the left eye image and the right eye image is a 2D image; and a glasses control unit that controls glasses such that a left eye shutter and a right eye shutter of the glasses are both opened, in a case where an image including the left eye image and the right eye image is a 2D image.

A display control method according to the first embodiment of the present disclosure corresponds to the display control device of the first embodiment of the present disclosure.

In other words, the display control method includes separating a multiplex image obtained by multiplexing a left eye image after decimation of a predetermined phase and a right eye image after decimation of a phase reverse to the predetermined phase, into the left eye image after the decimation and the right eye image after the decimation, interpolating the predetermined phase of the left eye image after the decimation with 0, and interpolating the phase reverse to the predetermined phase of the right eye image after the decimation with 0; using an interpolated left eye image obtained by interpolating the left eye image after the decimation as a left eye display image, using an interpolated right eye image obtained by interpolating the right eye image after the decimation as a right eye display image, and alternately displaying the left eye display image and the right eye display image, in a case where an image including the left eye image and the right eye image is a 2D image; and controlling glasses such that a left eye shutter and a right eye shutter of the glasses are both opened, in a case where an image including the left eye image and the right eye image is a 2D image.

According to a second embodiment of the present disclosure, there is provided an image generation device including a multiplexing unit that decimates a predetermined phase of a left eye image and a phase reverse to the predetermined phase of a right eye image and multiplexes the left eye image and the right eye image after the decimation; a distortion related information generation unit that generates distortion related information which is information regarding aliasing in a multiplex image obtained as a result of the multiplexing performed by the multiplexing unit; and a transmission unit that transmits the multiplex image and the distortion related information.

An image generation method according to the second embodiment of the present disclosure corresponds to the image generation device according to the second embodiment of the present disclosure.

In other words, the image generation method includes decimating a predetermined phase of a left eye image and a phase reverse to the predetermined phase of a right eye image, and multiplexing the left eye image and the right eye image after the decimation; generating distortion related information which is information regarding aliasing in a multiplex image obtained as a result of the multiplexing of the left eye image and the right eye image; and transmitting the multiplex image and the distortion related information.

According to a third embodiment of the present disclosure, there is provided a display control device including a separation unit that separates a multiplex image into a left eye image after decimation of a predetermined phase and a right eye image after decimation of a phase reverse to the predetermined phase, performs an interleave process for the left eye image after the decimation using the right eye image after the decimation, and performs an interleave process for the right eye image after the decimation using the left eye image after the decimation, in a case where an image including the left eye image and the right eye image which are sources of the multiplex image which is obtained by multiplexing the left eye image after the decimation and the right eye image after the decimation is a 2D image; a display control unit that uses a processed left eye image obtained by performing the interleave process for the left eye image after the decimation as a left eye display image, uses a processed right eye image obtained by performing the interleave process for the right eye image after the decimation as a right eye display image, and alternately displays the left eye display image and the right eye display image, in a case where an image including the left eye image and the right eye image is a 2D image; and a glasses control unit that controls glasses such that a left eye shutter of the glasses is opened when the left eye display image is displayed and a right eye shutter of the glasses is opened when the right eye display image is displayed.

A display control method according to the third embodiment of the present disclosure corresponds to the display control device according to the third embodiment of the present disclosure.

In other words, the display control method includes separating a multiplex image into a left eye image after decimation of a predetermined phase and a right eye image after decimation of a phase reverse to the predetermined phase, performing an interleave process for the left eye image after the decimation using the right eye image after the decimation, and performing an interleave process for the right eye image after the decimation using the left eye image after the decimation, in a case where an image including the left eye image and the right eye image which are sources of the multiplex image which is obtained by multiplexing the left eye image after the decimation and the right eye image after the decimation is a 2D image; using a processed left eye image obtained by performing the interleave process for the left eye image after the decimation as a left eye display image, using a processed right eye image obtained by performing the interleave process for the right eye image after the decimation as a right eye display image, and alternately displaying the left eye display image and the right eye display image in a case where an image including the left eye image and the right eye image is a 2D image; and controlling glasses such that a left eye shutter of the glasses is opened when the left eye display image is displayed and a right eye shutter of the glasses is opened when the right eye display image is displayed.

The display control devices and the image generation device according to the embodiments may be standalone devices or may be internal blocks forming a single device.

According to the first and third embodiments of the present disclosure, it is possible to further improve image quality of a 2D image for the left eye and a 2D image for the right eye after being restored in a case where the 2D image for the left eye and the 2D image for the right eye are multiplexed by decimating phases reverse to each other.

In addition, according to the second embodiment of the present disclosure, it is possible to transmit information for further improving image quality of a 2D image for the left eye and a 2D image for the right eye after being restored in a case where the 2D image for the left eye and the 2D image for the right eye are multiplexed by decimating phases reverse to each other.

### BRIEF DESCRIPTION OF THE DRAWINGS

FIG. 1 is a block diagram illustrating an example of a configuration of an image processing system in the related art.

FIG. 2 is a block diagram illustrating a configuration example of an image processing system according to a first embodiment of the present disclosure.

FIG. 3 is a diagram illustrating a multiplex image.

FIG. 4 is a diagram illustrating a description example of frame packing arrangement SEI.

FIG. 5 is a diagram illustrating a description example of 2D scene information SEI.

FIG. 6 is a diagram illustrating a multiplexing process in a case where an input image is a 2D image.

FIG. 7 is a diagram illustrating a separation process in a case where an input image is a 2D image.

FIG. 8 is a diagram illustrating the bandwidth in a case where an input image is a 2D image.

FIG. 9 is a diagram illustrating a multiplexing process in a case where an input image is a 3D image.

FIG. 10 is a diagram illustrating a separation process in a case where an input image is a 3D image.

FIG. 11 is a diagram illustrating the bandwidth in a case where an input image is a 3D image.

FIG. 12 is a flowchart illustrating an encoding process.

FIG. 13 is a flowchart illustrating a decoding process.

FIG. 14 is a block diagram illustrating a configuration example of an image processing system according to a second embodiment of the present disclosure.

FIG. 15 is a diagram illustrating a separation process in a case where an input image is a 2D image.

FIG. 16 is a flowchart illustrating a decoding process.

FIG. 17 is a block diagram illustrating a configuration example of an image processing system according to a third embodiment of the present disclosure.

FIG. 18 is a diagram illustrating a description example of 2D scene information SEI.

FIG. 19 is a flowchart illustrating an encoding process.

FIG. 20 is a flowchart illustrating a decoding process.

FIG. 21 is a diagram illustrating a configuration example of a computer according to an embodiment.

### DETAILED DESCRIPTION OF EMBODIMENTS

### First Embodiment

### Configuration Example of Image Processing System According to First Embodiment

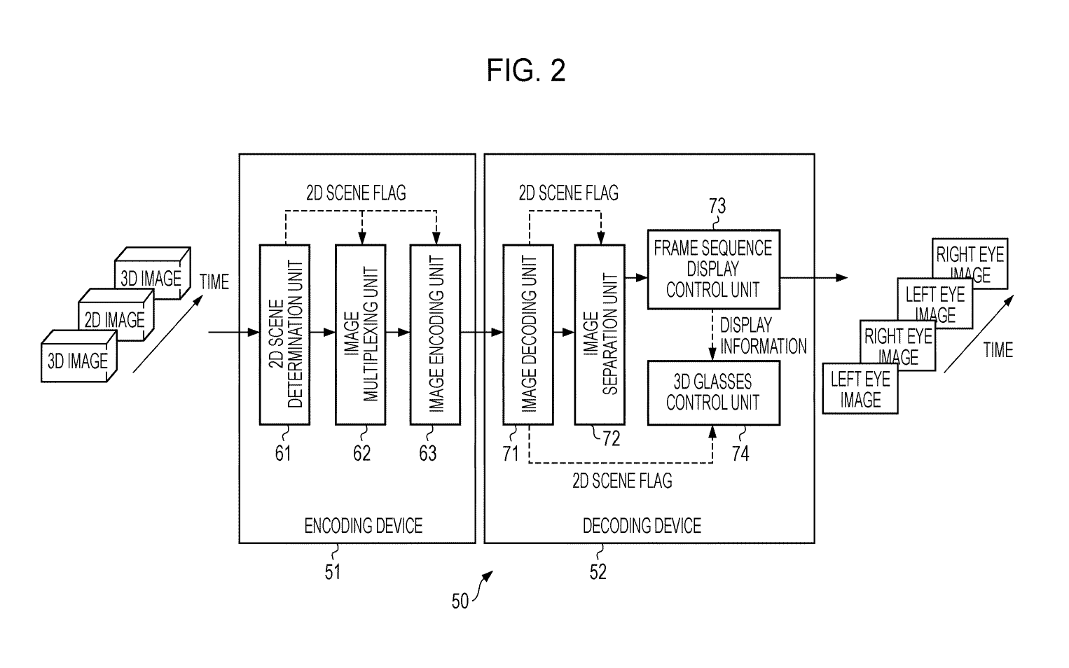

FIG. 2 is a block diagram illustrating a configuration example of an image processing system according to a first embodiment of the present disclosure.

The image processing system 50 in FIG. 2 includes an encoding device 51 and a decoding device 52. If an input image is a 2D image, the image processing system 50 does not perform a low pass filter process before multiplexing and after separation, and if an input image is a 3D image, the image processing system 50 performs the low pass filter process before the multiplexing and after the separation.

Specifically, the encoding device 51 includes a 2D scene determination unit 61, an image multiplexing unit 62, and an image encoding unit 63.

One bit stream in which 2D images and 3D images are mixed is input to the 2D scene determination unit 61 of the encoding device 51, and the 2D scene determination unit 61 obtains the 2D images or the 3D images as input images.

The 2D scene determination unit 61 determines whether or not the input images are 2D images. The determination method includes, for example, a method of determining whether or not left eye images and right eye images forming the input images are the same, a method of obtaining information indicating whether or not the input images are 2D images from an external device and determining based on the information, or the like. The 2D scene determination unit 61 (2D information generation unit) generates a 2D scene flag (2D information) which is a flag indicating a determination result, and supplies the 2D scene flag to the image multiplexing unit 62 and the image encoding unit 63. In addition, the 2D scene determination unit 61 supplies the input images to the image multiplexing unit 62.

The image multiplexing unit 62 performs a multiplexing process of multiplexing the input images by the side by side method, based on the 2D scene flag supplied from the 2D scene determination unit 61.

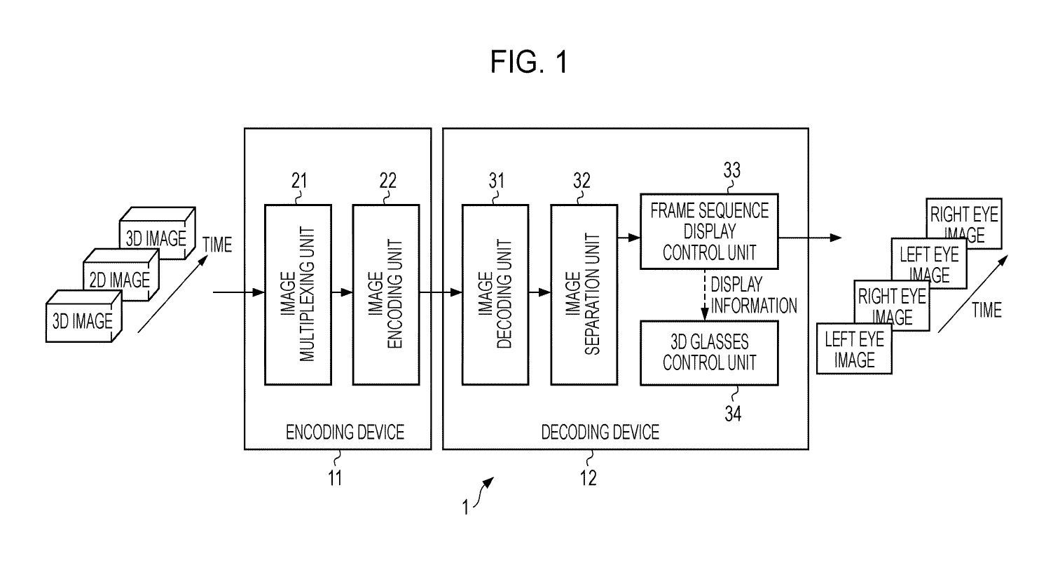

Specifically, if the 2D scene flag indicates that the input images are 2D images, the image multiplexing unit 62 does not perform the low pass filter process for the input images, and performs multiplexing for the input images as in the multiplexing by the image multiplexing unit 21 in FIG. 1. On the other hand, if the 2D scene flag indicates that the input images are not 2D images, the image multiplexing unit 62 performs the low pass filter process and the multiplexing for the input images in a manner similar to the multiplexing performed by the image multiplexing unit 21. The image multiplexing unit 62 supplies multiplex images obtained as a result of the multiplexing process to the image encoding unit 63.

The image encoding unit 63 performs encoding according to the AVC method using the multiplex images supplied from the image multiplexing unit 62 and the 2D scene flag supplied from the 2D scene determination unit 61. The image encoding unit 63 transmits an encoded stream obtained as a result thereof to the decoding device 52.

The decoding device 52 includes an image decoding unit 71, an image separation unit 72, a frame sequence display control unit 73, and a 3D glasses control unit 74.

The image decoding unit 71 (obtaining unit) of the decoding device 52 obtains the encoded stream from the image encoding unit 63 of the encoding device 51, and extracts the encoded multiplex images, the 2D scene flag, and the like from the encoded stream. The image decoding unit 71 decodes the encoded multiplex images by a method corresponding to the AVC method, and supplies multiplex images obtained as a result thereof to the image separation unit 72. In addition, the image decoding unit 71 supplies the 2D scene flag to the image separation unit 72 and the 3D glasses control unit 74.

The image separation unit 72 (separation unit) performs a separation process of separating each of the multiplex images supplied from the image decoding unit 71 into left and right half regions, based on the 2D scene flag supplied from the image decoding unit 71.

Specifically, if the 2D scene flag indicates that the input image is a 2D image, the image separation unit 72 respectively generates images having the same size as the input image from the left half region and the right half region of the multiplex image in a manner similar to the image separation unit 32 in FIG. 1. The image separation unit 72 does not perform the low pass filter process for the generated images, and uses the image generated from the left half region as a left eye display image as it is and the image generated from the right half region as a right eye display image as it is.

On the other hand, if the 2D scene flag indicates that the input image is not a 2D image, the image separation unit 72 performs a separation process which is similar to the separation process performed by the image separation unit 32. Further, the image separation unit 72 supplies a left eye display image and a right eye display image obtained as a result of the separation process to the frame sequence display control unit 73.

The frame sequence display control unit 73 (display control unit) alternately displays the left eye display image and the right eye display image supplied from the image separation unit 72 on a display device (not shown) at a high frame rate (for example, 240 p). In addition, the frame sequence display control unit 73 supplies display information to the 3D glasses control unit 74.

If the 2D scene flag supplied from the image decoding unit 71 indicates that the input image is a 2D image, the 3D glasses control unit 74 (glasses control unit) controls 3D glasses such that a left eye shutter (not shown) and a right eye shutter (not shown) of the 3D glasses are both opened based on the display information supplied from the frame sequence display control unit 73. Thereby, a user wearing the 3D glasses can view both of the left eye display image and the right eye display image displayed on the display device (not shown) with both eyes. As a result, the user can view bright 2D images because the amount of light reaching both eyes of the user increases, as compared with a case where the left eye display image is viewed with the left eye and the right eye display image is viewed the right eye.

On the other hand, if the 2D scene flag indicates that the input image are not a 2D image, in a manner similar to the 3D glasses control unit 34 in FIG. 1, the 3D glasses control unit 74 controls the 3D glasses such that the left eye shutter is opened when the left eye display image is displayed and the right eye shutter is opened when the right eye display image is displayed, based on the display information supplied from the frame sequence display control unit 73. Thereby, the user wearing the 3D glasses can view the left eye display image displayed on the display device (not shown) only with the left eye, and can view the right eye display image having a viewpoint different from the left eye display image only with the right eye. As a result, the user can view 3D images.

### Description of Multiplex Image

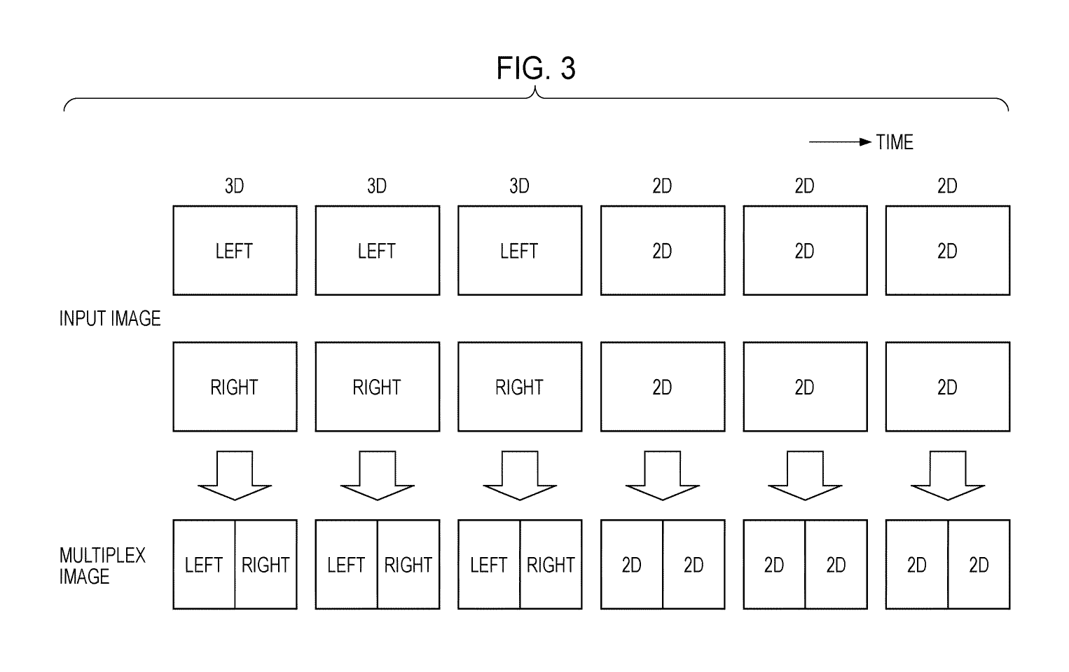

FIG. 3 is a diagram illustrating multiplex images generated by the image multiplexing unit 62 in FIG. 2.

As shown in FIG. 3, if the input images are 3D images, the input images are formed by left eye images LEFT and right eye images RIGHT having different viewpoints. On the other hand, if the input images are 2D images, the input images are formed by left eye images 2D and right eye images 2D having the same viewpoint.

In addition, as shown in FIG. 3, a multiplex image is generated in which a ½ reduced image of the left eye image of the input images is disposed at the left half region, and ½ reduced image of the right eye image thereof is disposed at the right half region.

### Description of Encoded Stream SEI

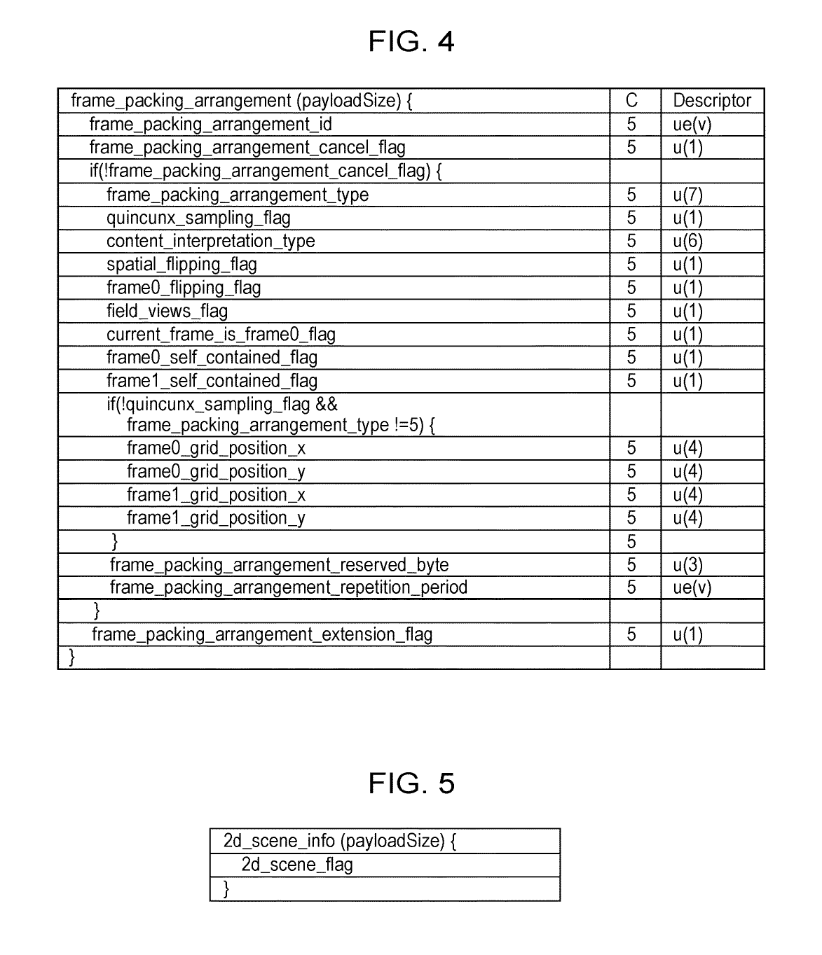

FIGS. 4 and 5 are diagrams illustrating a description example of SEI (Supplemental Enhancement Information) included in the encoded stream obtained by the image encoding unit 63.

FIG. 4 is a diagram illustrating a description example of frame packing arrangement SEI included in the encoded stream.

The frame packing arrangement SEI includes information (frame_packing_arrangement_type) indicating a multiplexing type as shown in the fifth row in FIG. 4. In addition, as shown in the fifteenth row, the frame packing arrangement SEI includes information (frame0_grid_position_x) indicating whether positions in the horizontal direction of pixels which are not decimated are odd numbered positions or even numbered positions when a left eye image is reduced in the multiplexing process.

Further, as shown in the sixteenth row, the frame packing arrangement SEI includes information (frame0_grid_position_y) indicating whether positions in the vertical direction of pixels which are not decimated are odd numbered positions or even numbered positions when a left eye image is reduced in the multiplexing process.

As shown in the seventeenth row, the frame packing arrangement SEI includes information (frame1_grid_position_x) indicating whether positions in the horizontal direction of pixels which are not decimated are odd numbered positions or even numbered positions when a right eye image is reduced in the multiplexing process. Further, as shown in the eighteenth row, the frame packing arrangement SEI includes information (frame1_grid_position_y) indicating whether positions in the vertical direction of pixels which are not decimated are odd numbered positions or even numbered positions when a right eye image is reduced in the multiplexing process.

In this embodiment, since pixels are not decimated based on positions in the vertical direction in the multiplexing process, none of the information (frame0_grid_position_y) and the information (frame1_grid_position_y) indicate the odd numbered positions and the even numbered positions.

FIG. 5 is a diagram illustrating a description example of 2D scene information SEI included in the encoded stream.

As shown in the second row in FIG. 5, the 2D scene flag SEI includes a 2D scene information (2d_scene_flag).

### Description of 2D Image Processing

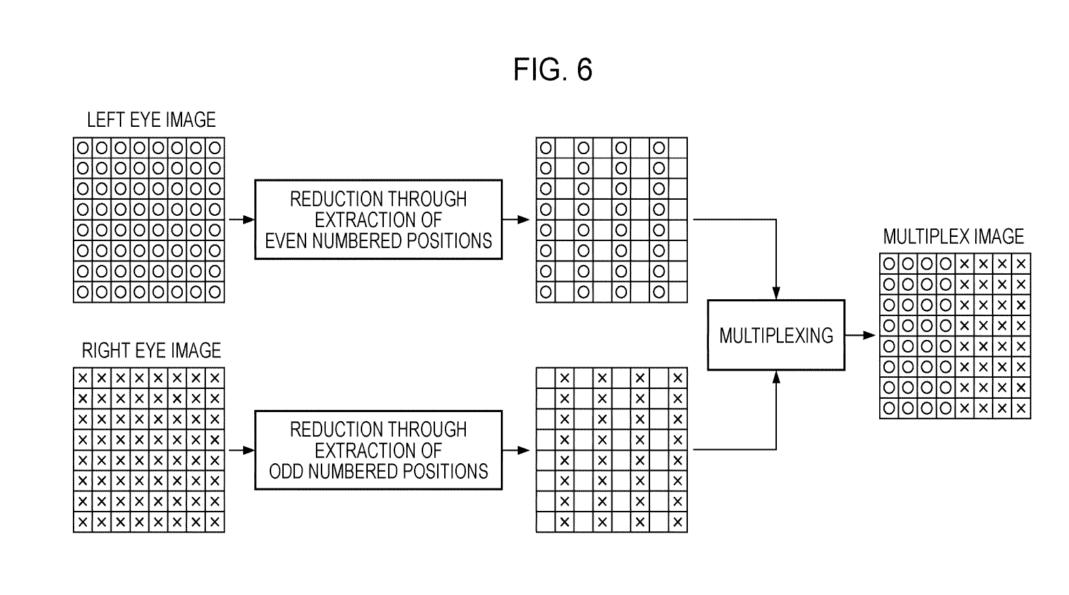

FIG. 6 is a diagram illustrating the multiplexing process in a case where input images are 2D images.

In the following embodiments, the left end of an image in the horizontal direction will be described as 0 (even numbered position) in FIGS. 6, 7, 9, 10 and 15.

As shown in FIG. 6, in a case where an input image are a 2D image, first, the image multiplexing unit 62 extracts pixels located at the even numbered positions in the horizontal direction from a left eye image of the input images, and reduces the left eye image by half. In other words, the image multiplexing unit 62 decimates pixels located at the odd numbered positions in the horizontal direction from the left eye image.

The the image multiplexing unit 62 extracts pixels located at the odd numbered positions in the horizontal direction from a right eye image of the input images, and reduces the right eye image by half. In other words, the image multiplexing unit 62 decimates pixels located at the even numbered positions in the horizontal direction from the right eye image. Next, the image multiplexing unit 62 performs the multiplexing by disposing the ½ reduced image of the left eye image at the left half region and the ½ reduced image of the right eye image at the right half region, thereby obtaining a multiplex image.

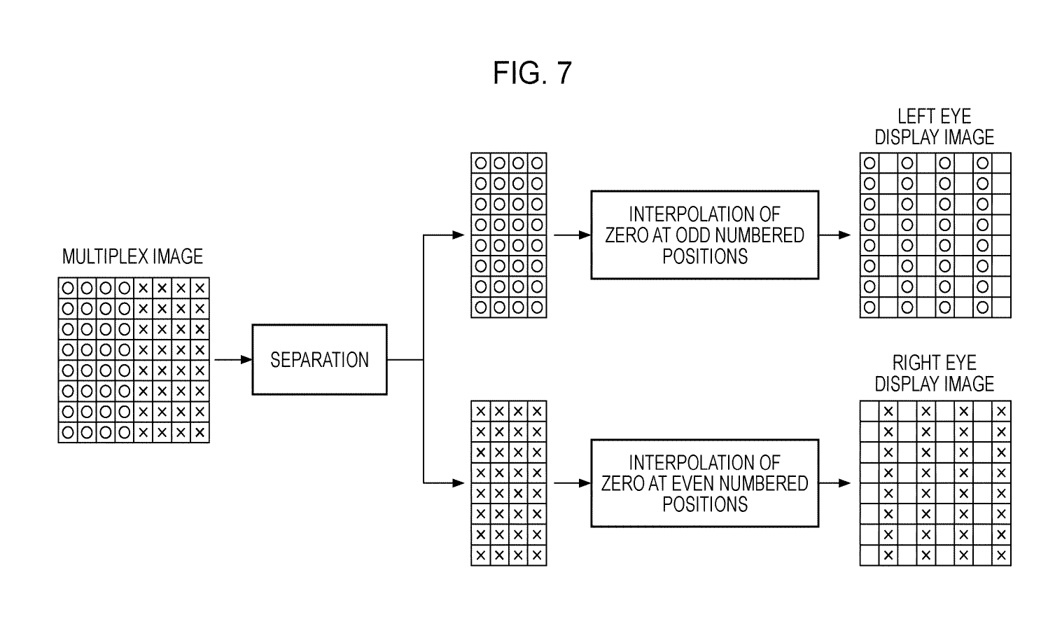

FIG. 7 is a diagram illustrating a separation process in a case where the input image which is a source of a multiplex image is a 2D image.

As shown in FIG. 7, in a case where the input image which is a source of a multiplex image is a 2D image, first, the image separation unit 72 separates the multiplex image into a left half region and a right half region. Next, the image separation unit 72 designates pixels of the left half region as pixels located at the even numbered positions in the horizontal direction, interpolates pixels located at the odd numbered positions in the horizontal direction with 0, so as to generate an image having the same size as the input image, and uses the generated image as a left eye display image. In addition, the image separation unit 72 designates pixels of the right half region as pixels located at the odd numbered positions in the horizontal direction, interpolates pixels located at the even numbered positions in the horizontal direction with 0, so as to generate an image having the same size as the input image, and uses the generated image as a right eye display image.

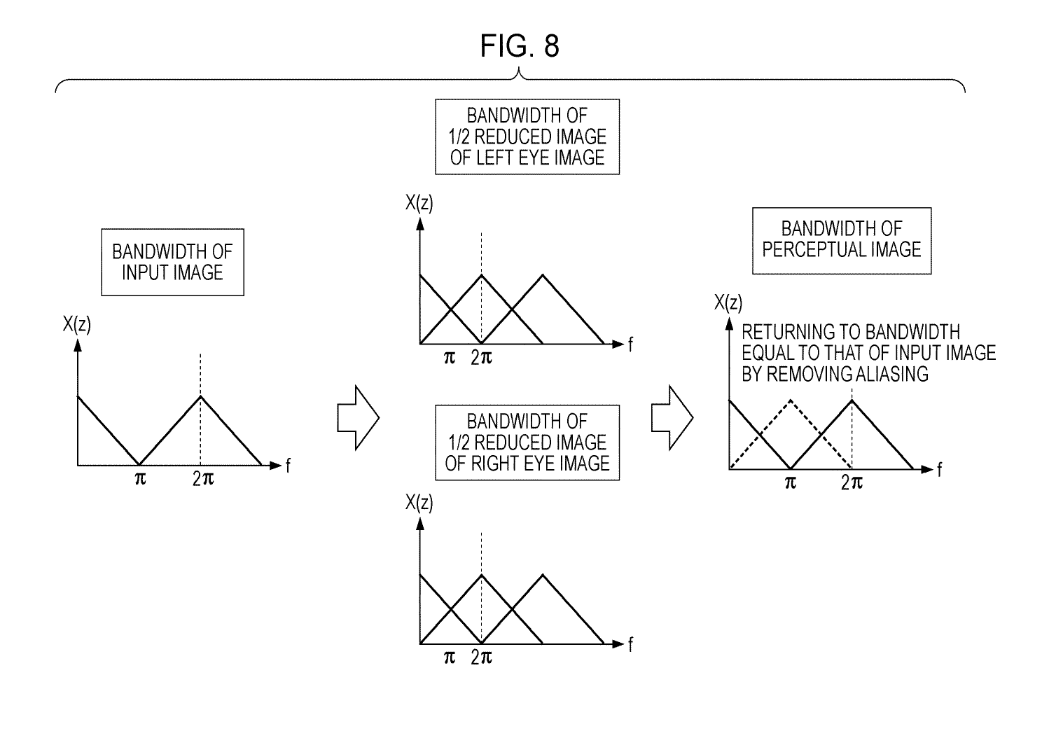

FIG. 8 is a diagram illustrating the bandwidths of the input image, the ½ reduced images, and an image which is displayed on a display device (not shown) and perceived by a user (hereinafter, referred to as a perceptual image) in a case where the input image is a 2D image. In the graph of FIG. 8, the transverse axis expresses a normalized frequency (f), and the longitudinal axis expresses energy (X(z)).

In the example shown in FIG. 8, the bandwidth of the input image is shown in the left side of FIG. 8. In the example shown in FIG. 8, the maximum normalized frequency of the input image is π, and a sampling frequency is 2π.

When the bandwidth of the input image is shown in the left side of FIG. 8, the bandwidths of the ½ reduced image of the left eye image and the ½ reduced image of the right eye image are shown in the center of FIG. 8. In other words, aliasing occurs because the bandwidth is not decreased to a half before reduction through the low pass filter process, however, the bandwidth is the same as the bandwidth of the input image.

Both of the left eye display image and the right eye display image obtained by multiplexing, encoding, decoding, and separating the ½ reduced image of the left eye image and the ½ reduced image of the right eye image are viewed with both eyes of a user, and the bandwidth of the perceptual image at this time is shown in the right side of FIG. 8. In other words, the bandwidth of the perceptual image is the same as the bandwidth of the input image, and aliasing does not occur.

The reason why aliasing does not occur will be described below.

The frame sequence display control unit 73 alternately displays the left eye display image and the right eye display image at a high frame rate, and the time interval between the left eye display image and the right eye display image which are continuously displayed is very short. As a result, the user can perceive an image where the left eye display image and the right eye display image which are temporally adjacent to each other are synthesized by viewing the image displayed on the display device (not shown) with both eyes.

In addition, in the left eye image and the right eye image, since the pixels with phases reverse to each other are decimated, if the left eye display image and the right eye display image where the decimated pixels are interpolated are synthesized, aliasing occurring due to the decimation cancels each other. As a result, aliasing does not occur in the perceptual image.

### Description of 3D Image Processing

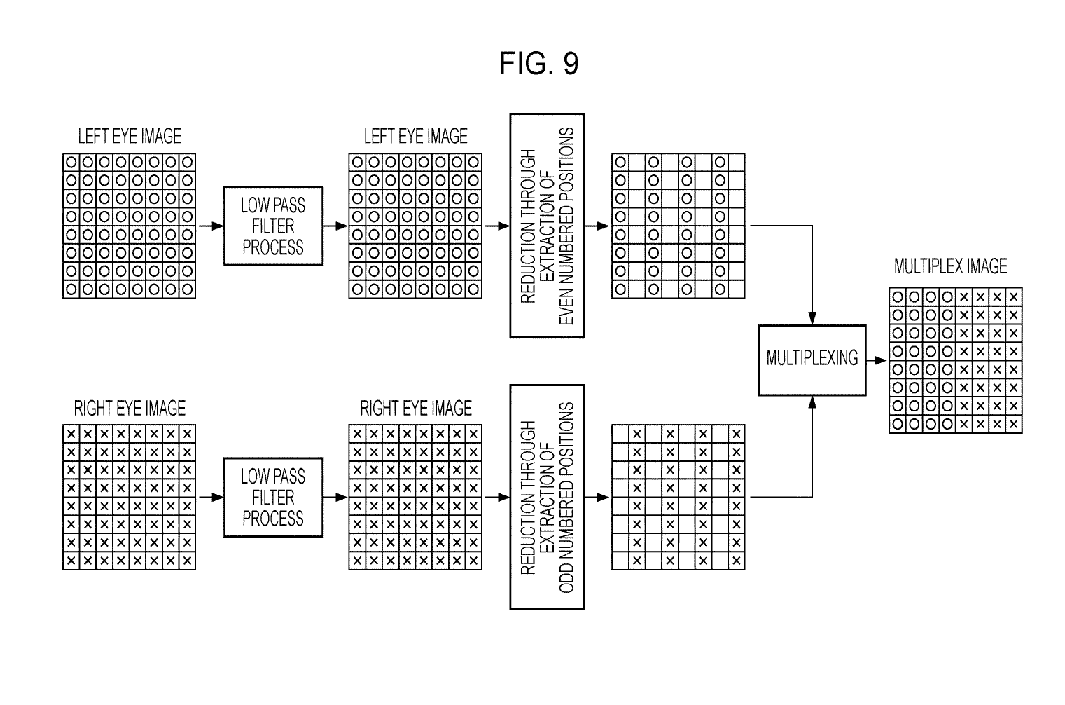

FIG. 9 is a diagram illustrating a multiplexing process in a case where the input image is a 3D image.

As shown in FIG. 9, in a case where the input image is a 3D image, first, the image multiplexing unit 62 performs the low pass filter process for a left eye image of the input image so as to decrease its bandwidth by half. In addition, the image multiplexing unit 62 performs the low pass filter process for a right eye image of the input image so as to decrease its bandwidth by half.

Next, the image multiplexing unit 62 extracts pixels located at the even numbered positions in the horizontal direction from the left eye image having undergone the low pass filter process, and reduces the left eye image by half. In addition, the image multiplexing unit 62 extracts pixels located at the odd numbered positions in the horizontal direction from the right eye image having undergone the low pass filter process, and reduces the right eye image by half. The image multiplexing unit 62 performs the multiplexing by disposing the ½ reduced image of the left eye image at the left half region and the ½ reduced image of the right eye image at the right half region, thereby obtaining a multiplex image.

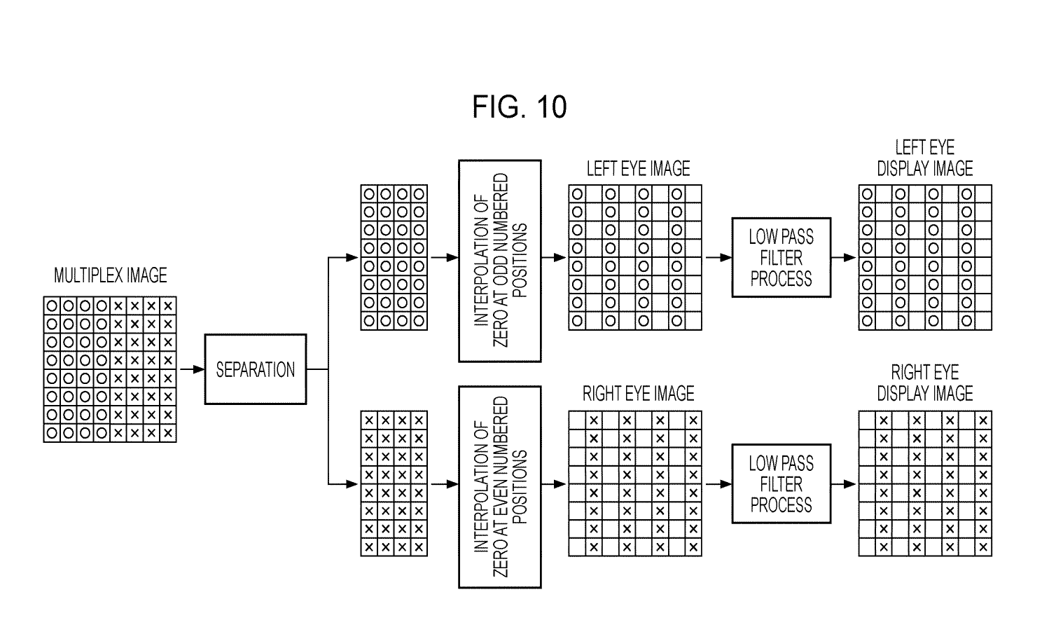

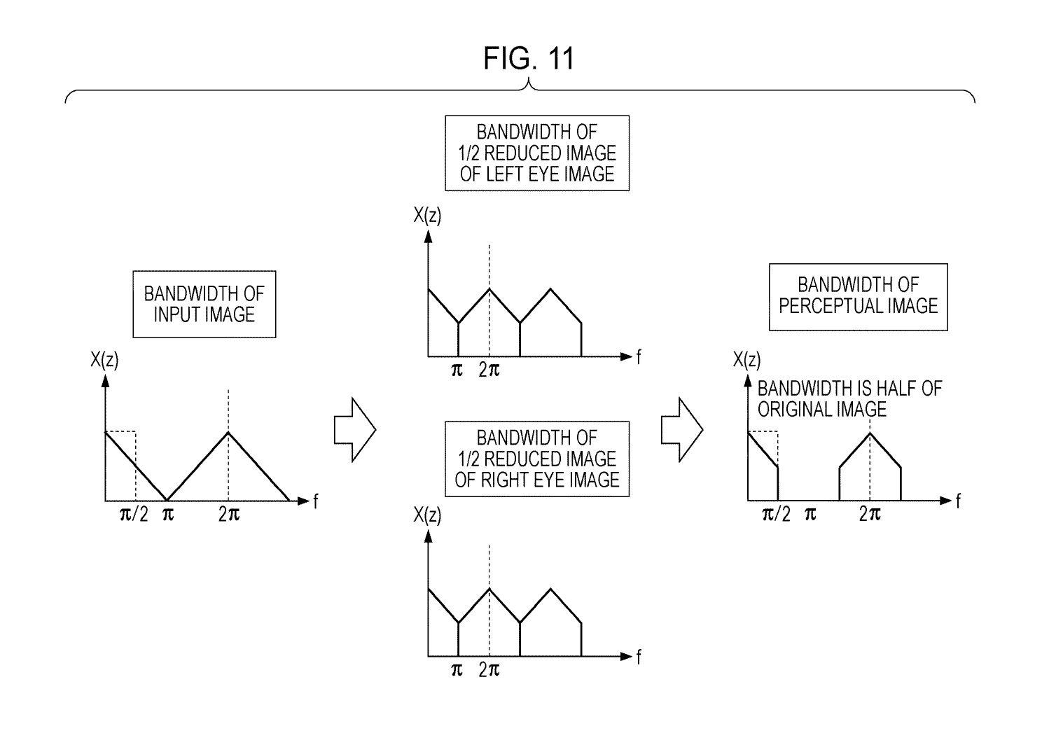

FIG. 10 is a diagram illustrating a separation process in a case where the input image which is a source of the multiplex image is a 3D image.

As shown in FIG. 10, in a case where the input image which is a source of the multiplex image is a 3D image, first, the image separation unit 72 separates the multiplex image into a left half region and a right half region. Next, the image separation unit 72 designates pixels of the left half region as pixels located at the even numbered positions in the horizontal direction, interpolates pixels located at the odd numbered positions in the horizontal direction with 0, thereby generating an image having the same size as the input image. In addition, the image separation unit 72 designates pixels of the right half region as pixels located at the odd numbered positions in the horizontal direction, interpolates pixels located at the even numbered positions in the horizontal direction with 0, thereby generating an image having the same size as the input image.

The image separation unit 72 performs the low pass filter process for the image having the same size as the input images, generated from the left half region of the multiplex image, and uses an image obtained as a result thereof as a left eye display image. Further, the image separation unit 72 performs the low pass filter process for the image having the same size as the input images, generated from the right half region of the multiplex image, and uses an image obtained as a result thereof as a right eye display image.

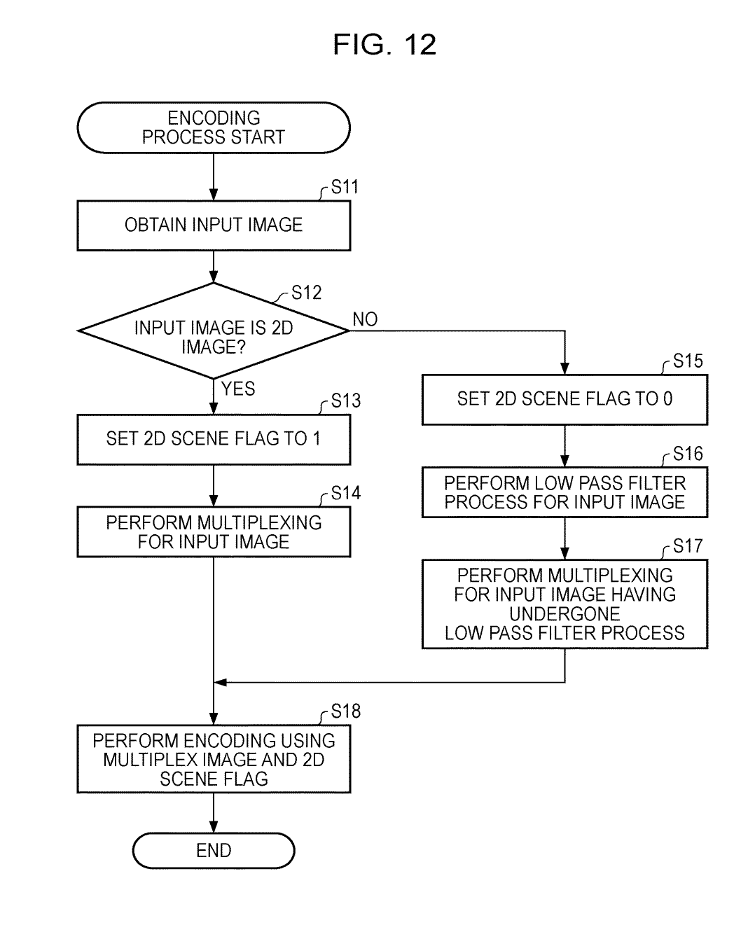

FIG. 11 is a diagram illustrating the bandwidths of the input image, the ½ reduced images, and a perceptual image in a case where the input image is a 3D image. In the graph of FIG. 11, the transverse axis expresses a normalized frequency (f), and the longitudinal axis expresses energy (X(z)).

In the example shown in FIG. 11, the bandwidth of the input image is shown in the left side of FIG. 11. In the example shown in FIG. 11, the maximum normalized frequency of the input image is π, and a sampling frequency is 2π.

When the bandwidth of the input image is shown in the left side of FIG. 11, the bandwidths of the ½ reduced image of the left eye image and the ½ reduced image of the right eye image are shown in the center of FIG. 11. In other words, the bandwidth is a half of the bandwidth of the input image because the bandwidth is decreased to a half before reduction through the low pass filter process, however, aliasing caused by the reduction does not occur in theory, but aliasing occurs in practice, even if only a little.

The left eye display image and the right eye display image obtained by multiplexing, encoding, decoding, and separating the ½ reduced image of the left eye image and the ½ reduced image of the right eye image are respectively viewed only with the left eye and the right eye of a user, and the bandwidth of the perceptual image at this time is shown in the right side of FIG. 11. In other words, the bandwidth of the perceptual image is a half of the bandwidth of the input image, however aliasing does not occur in theory.

### Description of Processes in Image Processing System

FIG. 12 is a flowchart illustrating an encoding process performed by the encoding device 51 of the image processing system 50 in FIG. 2. The encoding process starts, for example, when one bit stream including 2D images and 3D images is input to the encoding device 51.

In step S11 in FIG. 12, the 2D scene determination unit 61 obtains the 2D images or the 3D images which are included in the bit stream input to the encoding device 51 as input images, and supplies the input images to the image multiplexing unit 62. In addition, processes in steps S12 to S18 described later are performed for each input image of one frame formed by a left eye image and a right eye image.

In step S12, the 2D scene determination unit 61 whether or not the input image is a 2D image. If it is determined that the input image is a 2D image in step S12, in step S13, the 2D scene determination unit 61 sets the 2D scene flag to 1 so as to indicate that the input image is a 2D image, and supplies the 2D scene flag to the image multiplexing unit 62 and the image encoding unit 63.

In step S14, the image multiplexing unit 62 performs multiplexing which is similar to the multiplexing performed by the image multiplexing unit 21 in FIG. 1, for the input image, based on the 2D scene flag set to 1 supplied from the 2D scene determination unit 61. The image multiplexing unit 62 supplies a multiplex image obtained as a result of the multiplexing to the image encoding unit 63, and the flow goes to step S18.

On the other hand, if the input image is not a 2D image in step S12, that is, the input image is a 3D image, the flow goes to step S15. In step S15, the 2D scene determination unit 61 sets the 2D scene flag to 0 so as to indicate that the input image is not a 2D image, and supplies the 2D scene flag to the image multiplexing unit 62 and the image encoding unit 63.

In step S16, the image multiplexing unit 62 performs the low pass filter process for the input image in a manner similar to the image multiplexing unit 21, based on the 2D scene flag set to 0 supplied from the 2D scene determination unit 61.

In step S17, the image multiplexing unit 62 performs multiplexing for the input image having undergone the low pass filter process in a manner similar to the image multiplexing unit 21. In addition, the image multiplexing unit 62 supplies a multiplex image obtained as a result of the multiplexing to the image encoding unit 63, and the flow goes to step S18.

In step S18, the image encoding unit 63 performs encoding according to the AVC method using the multiplex image supplied from the image multiplexing unit 62 and the 2D scene flag supplied from the 2D scene determination unit 61. The image encoding unit 63 transmits an encoded stream obtained as a result thereof to the decoding device 52, and the processes finish.

As such, if the input image is a 2D image, the encoding device 51 performs the multiplexing without performing the low pass filter process, and thus the display resolution of the 2D image displayed in the decoding device 52 can become the same as the display resolution of the input image. In addition, it is possible to decrease a calculation amount corresponding to the low pass filter process. Further, the encoding device 51 can transmit the 2D scene flag to the decoding device 52.

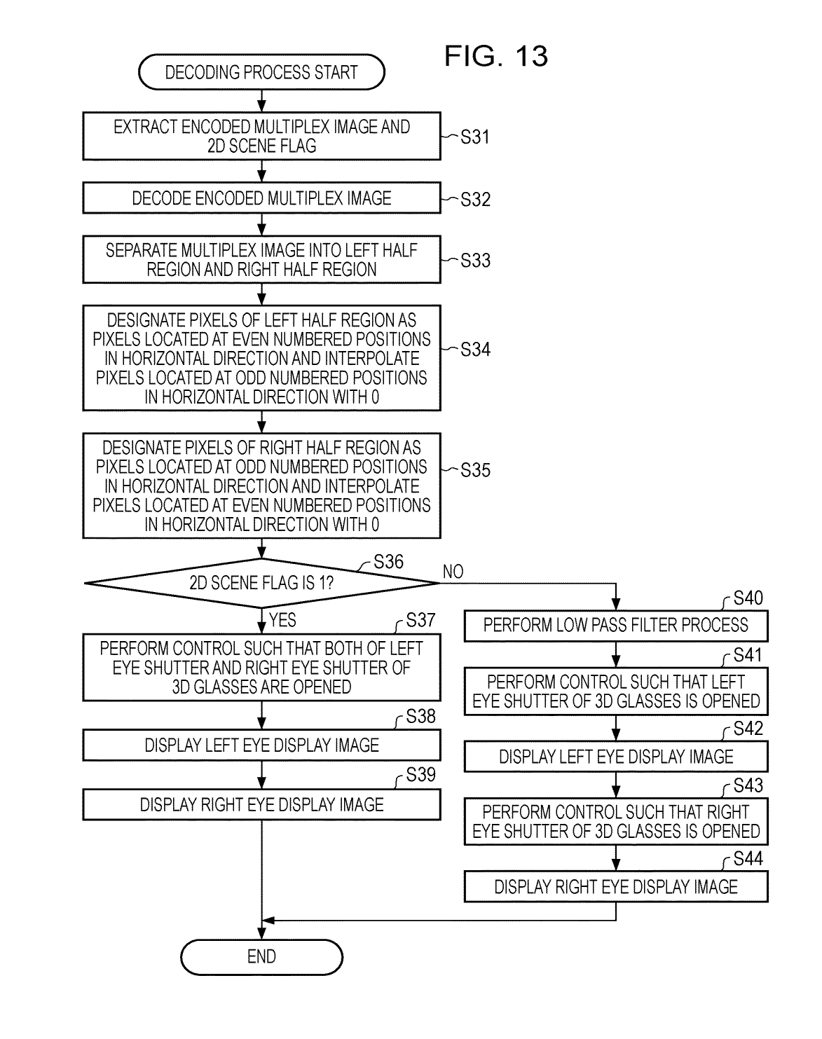

FIG. 13 is a flowchart illustrating a decoding process performed by the decoding device 52 of the image processing system 50 in FIG. 2. The decoding process is performed with picture units when the encoded stream is transmitted from the encoding device 51 of the image processing system 50.

In step S31 in FIG. 13, the image decoding unit 71 of the decoding device 52 obtains the encoded stream from the encoding device 51, and extracts the encoded multiplex image, the 2D scene flag, and the like from the encoded stream. In addition, the image decoding unit 71 supplies the 2D scene flag to the image separation unit 72 and the 3D glasses control unit 74.

In step S32, the image decoding unit 71 decodes the encoded multiplex image by a method corresponding to the AVC method, and supplies a multiplex image obtained as a result thereof to the image separation unit 72.

In step S33, the image separation unit 72 separates the multiplex image into a left half region and a right half region. In step S34, the image separation unit 72 designates pixels of the left half region as pixels located at the even numbered positions in the horizontal direction, interpolates pixels located at the odd numbered positions in the horizontal direction with 0, thereby generating an image having the same size as the input image. In step S35, the image separation unit 72 designates pixels of the right half region as pixels located at the odd numbered positions in the horizontal direction, interpolates pixels located at the even numbered positions in the horizontal direction with 0, thereby generating an image having the same size as the input image.

In step S36, the image separation unit 72 determines whether or not the 2D scene flag supplied from the image decoding unit 71 is 1.

If it is determined that the 2D scene flag is 1 in step S36, the image separation unit 72 supplies, to the frame sequence display control unit 73, the image generated in step S34 as a left eye display image as it is and the image generated in step S35 as a right eye display image as it is. The frame sequence display control unit 73 supplies display information indicating that a display target is the left eye display image, to the 3D glasses control unit 74. In step S37, the 3D glasses control unit 74 controls 3D glasses (not shown) such that a left eye shutter and a right eye shutter of the 3D glasses are both opened.

In step S38, the frame sequence display control unit 73 displays the left eye display image supplied from the image separation unit 72 on a display device (not shown). The frame sequence display control unit 73 supplies display information indicating that a display target is the right eye display image to the 3D glasses control unit 74. In step S39, the frame sequence display control unit 73 displays the right eye display image supplied from the image separation unit 72 on the display device (not shown), and the processes finish.

On the other hand, if it is determined that the 2D scene flag is not 1 in step S36, that is, the 2D scene flag is 0, the flow goes to step S40.

In step S40, the image separation unit 72 performs the low pass filter process for the image generated in step S34 and the image generated in step S35. The image separation unit 72 uses an image obtained as a result of performing the low pass filter process for the image generated in step S34, as a left eye display image. In addition, the image separation unit 72 uses an image obtained as a result of performing the low pass filter process for the image generated in step S35, as a right eye display image. The image separation unit 72 supplies the left eye display image and the right eye display image to the frame sequence display control unit 73, and the frame sequence display control unit 73 supplies display information indicating that a display target is the left eye display image to the 3D glasses control unit 74.

In step S41, the 3D glasses control unit 74 controls the 3D glasses (not shown) such that the left eye shutter of the 3D glasses is opened based on the display information supplied from the frame sequence display control unit 73.

In step S42, the frame sequence display control unit 73 displays the left eye display image supplied from the image separation unit 72 on the display device (not shown). In addition, the frame sequence display control unit 73 supplies display information indicating that a display target is the right eye display image to the 3D glasses control unit 74.

In step S43, the 3D glasses control unit 74 controls the 3D glasses (not shown) such that the right eye shutter of the 3D glasses is opened based on the display information supplied from the frame sequence display control unit 73.

In step S44, the frame sequence display control unit 73 displays the right eye display image supplied from the image separation unit 72 on the display device (not shown), and the processes finish.

As such, if the input image which is a source of the multiplex image is a 2D image, the decoding device 52 does not perform the low pass filter process after the multiplex image is separated, and uses the separated images as display images as they are. Therefore, the display resolution of the 2D image can become the same as the display resolution of the input image. In addition, it is possible to decrease a calculation amount corresponding to the low pass filter process.

Further, since the decoding device 52 alternately displays the left eye display image and the right eye display image at a high frame rate, and controls the 3D glasses such that both of the left eye shutter and the right eye shutter of the 3D glasses are opened, aliasing occurring in the left eye display image and the right eye display image is removed, and thus it is possible to prevent a user from perceiving the aliasing.

### Second Embodiment

### Configuration Example of Image Processing System According To Second Embodiment

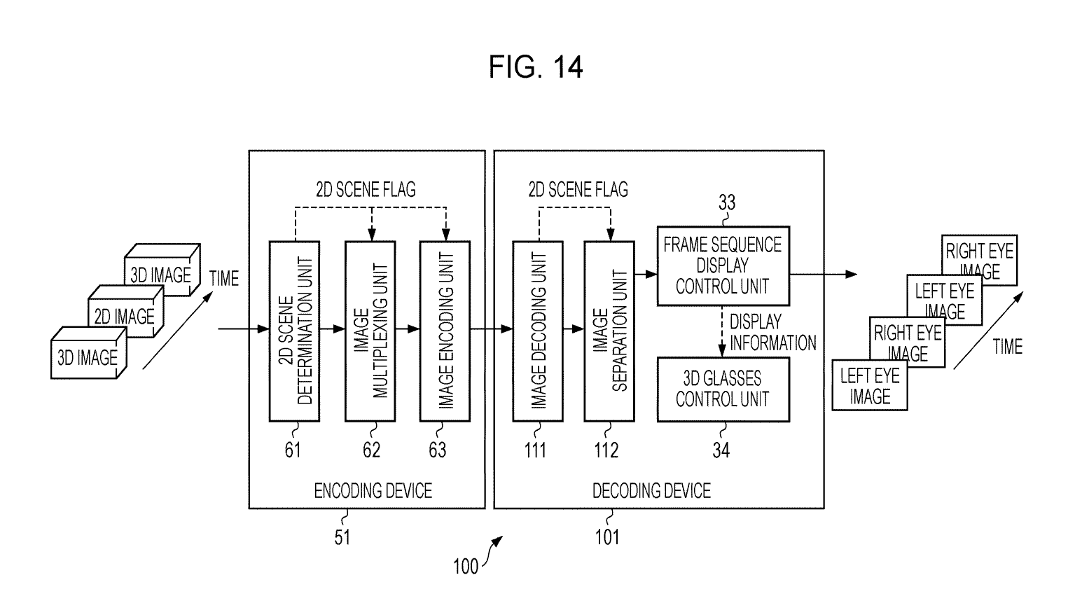

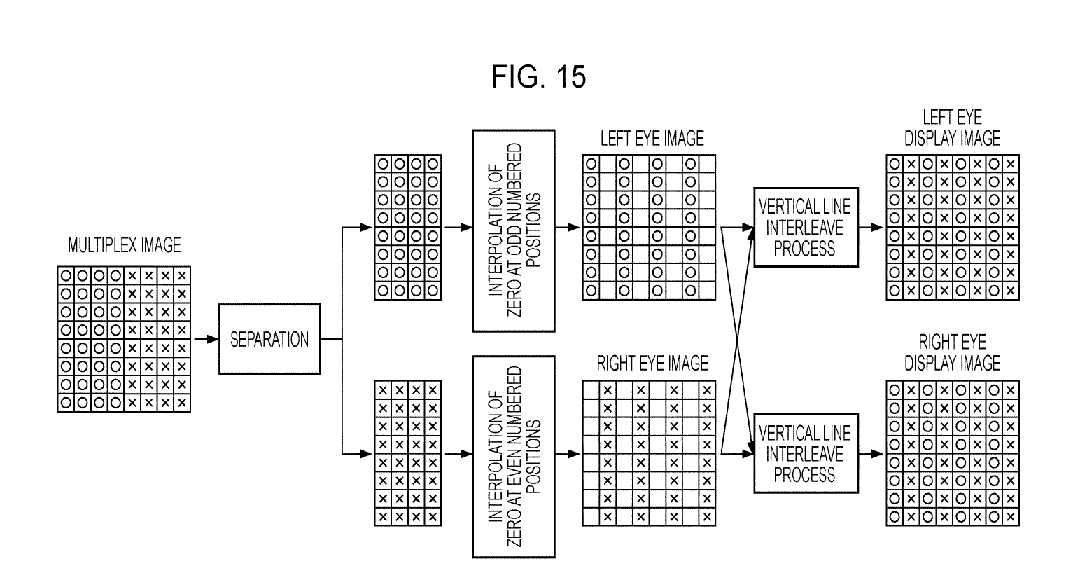

FIG. 14 is a block diagram illustrating a configuration example of an image processing system according to a second embodiment of the present disclosure.

Among the constituent elements shown in FIG. 14, the same constituent elements as those in FIG. 1 or FIG. 2 are given the same reference numerals. Repeated description will be appropriately omitted.

A configuration of an image processing system 100 in FIG. 14 is mainly different from the configuration in FIG. 2 in that a decoding device 101 is provided instead of the decoding device 52. The decoding device 101 of the image processing system 100 generates identical images, as a left eye display image and a right eye display image of 2D images, and alternately opens and closes the left eye shutter and the right eye shutter of the 3D glasses regardless of whether a display target is a 3D image or a 2D image.

Specifically, the decoding device 101 includes a frame sequence display control unit 33, a 3D glasses control unit 34, an image decoding unit 111, and an image separation unit 112.

The image decoding unit 111 (obtaining unit) of the decoding device 101 obtains an encoded stream from the image encoding unit 63 of the encoding device 51, and extracts an encoded multiplex image, a 2D scene flag, and the like from the encoded stream in a manner similar to the image decoding unit 71 in FIG. 2. The image decoding unit 111 decodes the encoded multiplex image by a method corresponding to the AVC method, and supplies a multiplex image obtained as a result thereof to the image separation unit 112 in a manner similar to the image decoding unit 71. In addition, the image decoding unit 111 supplies the 2D scene flag to the image separation unit 112.

The image separation unit 112 performs a separation process of separating the multiplex image supplied from the image decoding unit 111 into left and right half regions, based on the 2D scene flag supplied from the image decoding unit 111.

Specifically, if the 2D scene flag indicates that an input image is a 2D image, the image separation unit 112 (separation unit) respectively generates images having the same size as the input image from the left half region and the right half region of the multiplex image in a manner similar to the image separation unit 32 in FIG. 1. The image separation unit 112 does not perform the low pass filter process for the generated images, but performs a vertical line interleave process for the image generated from the left half region of the multiplex image, using the image generated from the right half region, and uses an image obtained as a result thereof as a left eye display image. The image separation unit 112 performs the vertical line interleave process for the image generated from the right half region of the multiplex image, using the image generated from the left half region, and uses an image obtained as a result thereof as a right eye display image.

On the other hand, if the 2D scene flag indicates that the input image is not a 2D image, the image separation unit 112 performs a separation process which is similar to the separation process performed by the image separation unit 32. Further, the image separation unit 112 supplies a left eye display image and a right eye display image obtained as a result of the separation process to the frame sequence display control unit 33.

### Description of 2D Image Processing

FIG. 15 is a diagram illustrating a separation process in a case where an input image which is a source of a multiplex image is a 2D image.

As shown in FIG. 15, in a case where an input image corresponding to a multiplex image is a 2D image, first, the image separation unit 112 separates the multiplex image into a left half region and a right half region. Next, the image separation unit 112 designates pixels of the left half region as pixels located at the even numbered positions in the horizontal direction, interpolates pixels located at the odd numbered positions in the horizontal direction with 0, thereby generating an image having the same size as the input image. In addition, the image separation unit 72 designates pixels of the right half region as pixels located at the odd numbered positions in the horizontal direction, interpolates pixels located at the even numbered positions in the horizontal direction with 0, thereby generating an image having the same size as the input image.

The image separation unit 112 performs the vertical line interleave process for the image generated from the left half region of the multiplex image using the image generated from the right half region. As a result, the pixels located at the odd numbered positions in the horizontal direction in the image generated from the left half region of the multiplex image are replaced with the pixels located at the odd numbered positions in the horizontal direction in the image generated from the right half region, and the resultant image is used as a left eye display image.

In addition, the image separation unit 112 performs the vertical line interleave process for the image generated from the right half region of the multiplex image using the image generated from the left half region. As a result, the pixels located at the even numbered positions in the horizontal direction in the image generated from the right half region of the multiplex image are replaced with the pixels located at the even numbered positions in the horizontal direction in the image generated from the left half region, and the resultant image is used as a right eye display image.

Therefore, in the left eye display image and the right eye display image, aliasing occurring in the image generated from the left half region of the multiplex image and the image generated from the right half region thereof cancels each other. Therefore, odd in a case where the left eye shutter and the right eye shutter of the 3D glasses are alternately opened and closed, and thus only one of the left eye display image and the right eye display image is viewed with one eye, it is possible to prevent a user from perceiving the aliasing.

### Description of Processes in Image Processing System

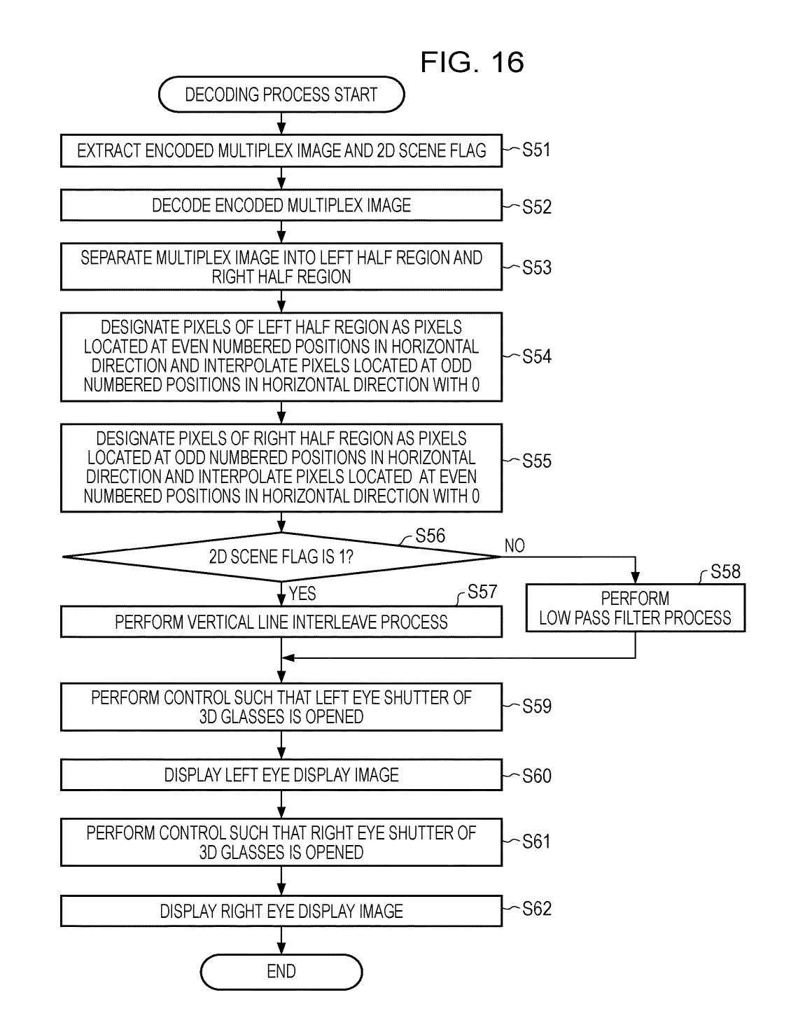

FIG. 16 is a flowchart illustrating a decoding process performed by the decoding device 101 of the image processing system 100 in FIG. 14. The decoding process is performed with picture units when the encoded stream is transmitted from the encoding device 51 of the image processing system 100.

The processes in steps S51 to S56 in FIG. 16 are similar to those in steps S31 to S36 in FIG. 13, and thus the description thereof will be omitted.

If it is determined that the 2D scene flag is 1 in step S56, the flow goes to step S57. In step S57, the image separation unit 112 performs the vertical line interleave process for the image generated in step S54 using the image generated in step S55, and uses an image obtained as a result thereof as a left eye display image. In addition, the image separation unit 112 performs the vertical line interleave process for the image generated in step S55 using the image generated in step S54, and uses an image obtained as a result thereof as a right eye display image. Further, the image separation unit 112 supplies the left eye display image and the right eye display image to the frame sequence display control unit 33, and the frame sequence display control unit 33 supplies display information indicating that a display target is the left eye display image to the 3D glasses control unit 34. The flow goes to step S59.

On the other hand, if it is determined that the 2D scene flag is not 1 in step S56, the flow goes to step S58. In step S58, the image separation unit 112 performs the low pass filter process for the image generated in step S54 and the image generated in step S55 in a manner similar to the process in step S40 in FIG. 13. The image separation unit 112 uses an image obtained as a result of performing the low pass filter process for the image generated in step S54, as a left eye display image. In addition, the image separation unit 112 uses an image obtained as a result of performing the low pass filter process for the image generated in step S55, as a right eye display image. Further, the image separation unit 112 supplies the left eye display image and the right eye display image to the frame sequence display control unit 33, and the frame sequence display control unit 33 supplies display information indicating that a display target is the left eye display image to the 3D glasses control unit 34. The flow goes to step S59.

The processes in steps S59 to S62 are similar to the processes in steps S41 to S44 in FIG. 13, and thus the description thereof will be omitted.

As such, in a case where an image which is a source of the multiplex image is a 2D image, the decoding device 101 of the image processing system 100 performs the vertical line interleave process for one of the images of two frames, which are separated from the multiplex image and interpolated with 0, and in which aliasing occurs, using the other image.

Therefore, aliasing is removed from the left eye display image and the right eye display image which are obtained as a result of the vertical line interleave process. As a result, even in a case where the left eye shutter and the right eye shutter of the 3D glasses are alternately opened and closed, it is possible to prevent a user from perceiving the aliasing.

In addition, in a case where the input image which is a source of the multiplex image is a 2D image, since the decoding device 101 does not perform the low pass filter process after the multiplex image is separated, the display resolution of the 2D image can become the same as the display resolution of the input image before being encoded.

Although the low pass filter process is not performed before the multiplexing and after the separation in a case where the input image is a 2D image in the first and second embodiments, a low pass filter process having a wide passband may be performed so as to pass a frequency component higher than in the low pass filter process performed in a case where an input image is a 3D image. In this case, the display resolution of the 2D image is not the same as the display resolution of the input image, but is improved as compared with the case where the bandwidth of the input image is decreased by half through the low pass filter process.

### Third Embodiment

### Configuration Example of Image Processing System According To Third Embodiment

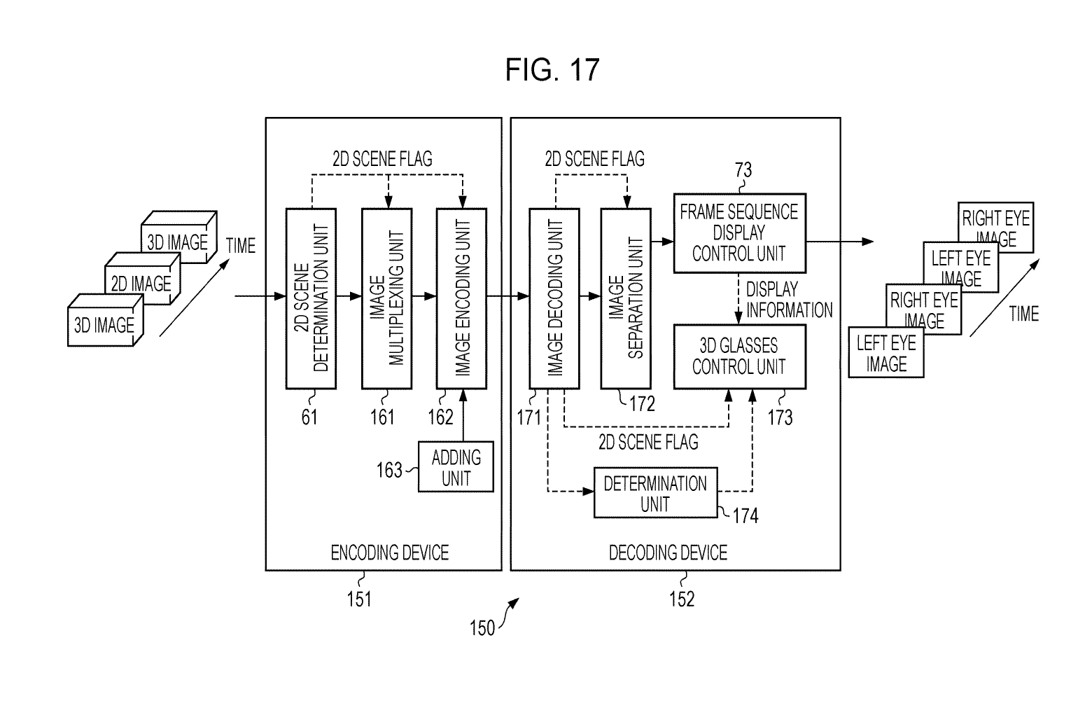

FIG. 17 is a block diagram illustrating a configuration example of an image processing system according to a third embodiment of the present disclosure.

Among the constituent elements shown in FIG. 17, the same constituent elements as those in FIG. 2 are given the same reference numerals. Repeated description will be appropriately omitted.

An image processing system 150 in FIG. 17 includes an encoding device 151 and a decoding device 152. The image processing system 150 controls the shutters of the 3D glasses based on existence or absence of aliasing included in a multiplex image of a 2D image, and a frame rate when display is performed (hereinafter, referred to as a display frame rate).

Specifically, a configuration of the encoding device 151 is mainly different from the configuration in FIG. 2 in that an image multiplexing unit 161 and an image encoding unit 162 are provided instead of the image multiplexing unit 62 and the image encoding unit 63, and an adding unit 163 is newly provided.

The image multiplexing unit 161 of the encoding device 151 performs a multiplexing process of multiplexing an input image by the side by side method, based on a 2D scene flag supplied from the 2D scene determination unit 61.

Specifically, if the 2D scene flag indicates that an input image is a 2D image, the image multiplexing unit 161 performs a low pass filter process having a wide passband for the input image so as to pass a frequency component higher than in the low pass filter process performed in a case where the input image is a 3D image. The image multiplexing unit 161 (multiplexing unit) performs multiplexing similar to the multiplexing performed by the image multiplexing unit 21 in FIG. 1, for the input image having undergone the low pass filter process.

On the other hand, if the 2D scene flag indicates that the input image is not a 2D image, image multiplexing unit 161 performs the low pass filter process and the multiplexing for the input image in a manner similar to the process performed by the image multiplexing unit 21. The image multiplexing unit 161 supplies a multiplex image obtained as a result of the multiplexing process to the image encoding unit 162.

The image encoding unit 162 performs encoding according to the AVC method using the multiplex image supplied from the image multiplexing unit 161, the 2D scene flag supplied from the 2D scene determination unit 61, and a distortion flag and minimum display frame rate information supplied from the adding unit 163. The distortion flag (distortion information) is information indicating whether or not aliasing exists in a multiplex image. In addition, the minimum display frame rate is information indicating a minimum value of a display frame rate (display rate) which is estimated to prevent aliasing from occurring in a perceptual image by the decoding device 152. The image encoding unit 162 (transmission unit) transmits an encoded stream obtained as a result thereof to the decoding device 152.

In a case where the input image is a 2D image, the adding unit 163 (distortion related information generating unit) generates a distortion flag which is information regarding aliasing in the multiplex image (hereinafter, referred to as distortion related information), in response to an indication from a user.

Specifically, if the input image is a 2D image, the user allows, for example, the multiplex image obtained by the image multiplexing unit 161 to be displayed on a display device (not shown), and determines whether or not aliasing equal to or more than a predetermined amount occurs in the multiplex image. If it is determined that aliasing equal to or more than the predetermined amount occurs in the multiplex image, the user indicates existence of aliasing, and if it is determined that aliasing equal to or more than the predetermined amount does not occur, the user indicates absence of aliasing. The adding unit 163 generates the distortion flag depending on the indication.

In a case where the distortion flag indicating the existence of aliasing is generated, the adding unit 163 generates the minimum display frame rate information as distortion related information depending on the indication from the user. Specifically, if it is determined that aliasing equal to or more than the predetermined amount occurs in the multiplex image, the user decides a minimum value (for example, 120 Hz) of the display frame rate estimated to prevent aliasing from occurring in a perceptual image by the decoding device 152 based on an amount of aliasing or the like, and indicates it. The adding unit 163 generates the minimum display frame rate information depending on the indication.

The adding unit 163 supplies the generated distortion flag and the minimum display frame rate.

The configuration of the decoding device 152 is different from the configuration in FIG. 2 in that an image decoding unit 171, an image separation unit 172, and a 3D glasses control unit 173 are provided instead of the image decoding unit 71, the image separation unit 72, and the 3D glasses control unit 74, and a determination unit 174 is newly provided.

The image decoding unit 171 of the decoding device 152 obtains the encoded stream from the image encoding unit 162 of the encoding device 151, and extracts the encoded multiplex image, the 2D scene flag, the distortion flag, the minimum display frame rate, and the like from the encoded stream. The image decoding unit 171, in a manner similar to the image decoding unit 71 in FIG. 2, decodes the encoded multiplex image by a method corresponding to the AVC method, and supplies a multiplex image obtained as a result thereof to the image separation unit 172. In addition, the image decoding unit 171 supplies the 2D scene flag to the image separation unit 172 and the 3D glasses control unit 173 in a manner similar to the image decoding unit 71. Further, the image decoding unit 171 supplies the distortion flag and the minimum display frame rate to the determination unit 174.

The image separation unit 172 performs a separation process of separating the multiplex image supplied from the image decoding unit 171 into left and right half regions, based on the 2D scene flag supplied from the image decoding unit 171. Specifically, if the 2D scene flag indicates that the input image is a 2D image, the image separation unit 172 respectively generates images having the same size as the input image from the left half region and the right half region of the multiplex image in a manner similar to the image separation unit 32 in FIG. 1. The image separation unit 172 performs, for the generated images, a low pass filter process having a wider passband than the low pass filter process performed in a case where the 2D scene flag indicates the input image is not a 2D image. The image separation unit 172 uses the image generated from the left half region, having undergone the low pass filter process, as a left eye display image, and uses the image generated from the right half region, having undergone the low pass filter process, as a right eye display image.

On the other hand, if the 2D scene flag indicates that the input image is not a 2D image, the image separation unit 172 performs a separation process similar to the process performed by the image separation unit 32. In addition, the image separation unit 172 supplies a left eye display image and a right eye display image obtained as a result of the separation process, to the frame sequence display control unit 73.

If the 2D scene flag supplied from the image decoding unit 171 indicates that the input image is a 2D image, the 3D glasses control unit 173 controls the 3D glasses (not shown) such that both of the left eye shutter and the right eye shutter of the 3D glasses are opened, based on display information supplied from the frame sequence display control unit 73 in response to an instruction from the determination unit 174. Alternatively, the 3D glasses control unit 173 controls the 3D glasses such that the left eye shutter is opened when the left eye display image is displayed and the right eye shutter is opened when the right eye display image is displayed, based on display information supplied from the frame sequence display control unit 73 in response to an instruction from the determination unit 174.

On the other hand, if the 2D scene flag indicates that the input image is not a 2D image, the 3D glasses control unit 173 controls the 3D glasses such that the left eye shutter is opened when the left eye display image is displayed and the right eye shutter is opened when the right eye display image is displayed, based on display information supplied from the frame sequence display control unit 73.

The determination unit 174 determines whether the left eye shutter and the right eye shutter of the 3D glasses are both opened or alternately opened, based on the distortion flag supplied from the image decoding unit 171, and instructs the 3D glasses control unit 173 to perform it. In addition, when the minimum display frame rate information is supplied from the image decoding unit 171, the determination unit 174 performs the determination based on not only the distortion flag but also the minimum value indicated by the minimum display frame rate information and the display frame rate in the frame sequence display control unit 73.

### Description of SEI of Encoded Stream

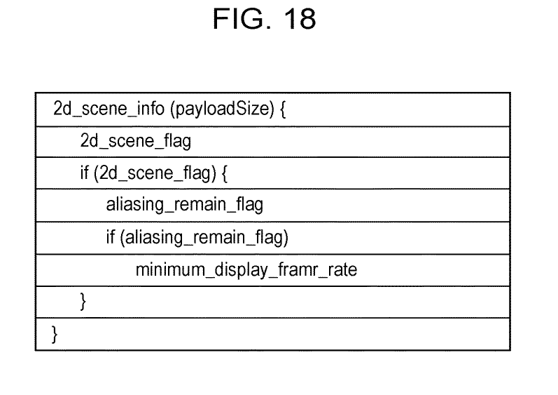

FIG. 18 is a diagram illustrating a description example of 2D scene information SEI included in an encoded stream obtained by the image encoding unit 162.

As shown in the second row in FIG. 18, the 2D scene information SEI includes a 2D scene flag (2d_scene_flag). As shown in the third and fourth rows, if the 2D scene flag is 1, that is, an input image is a 2D image, the 2D scene information SEI includes a distortion flag (aliasing_remain_flag). In addition, as shown in the fifth and sixth rows, if the distortion flag is 1, which indicates that aliasing exists, the 2D scene information SEI includes a minimum display frame rate (minimum_display_frame_rate).

### Description of Process in Image Processing System

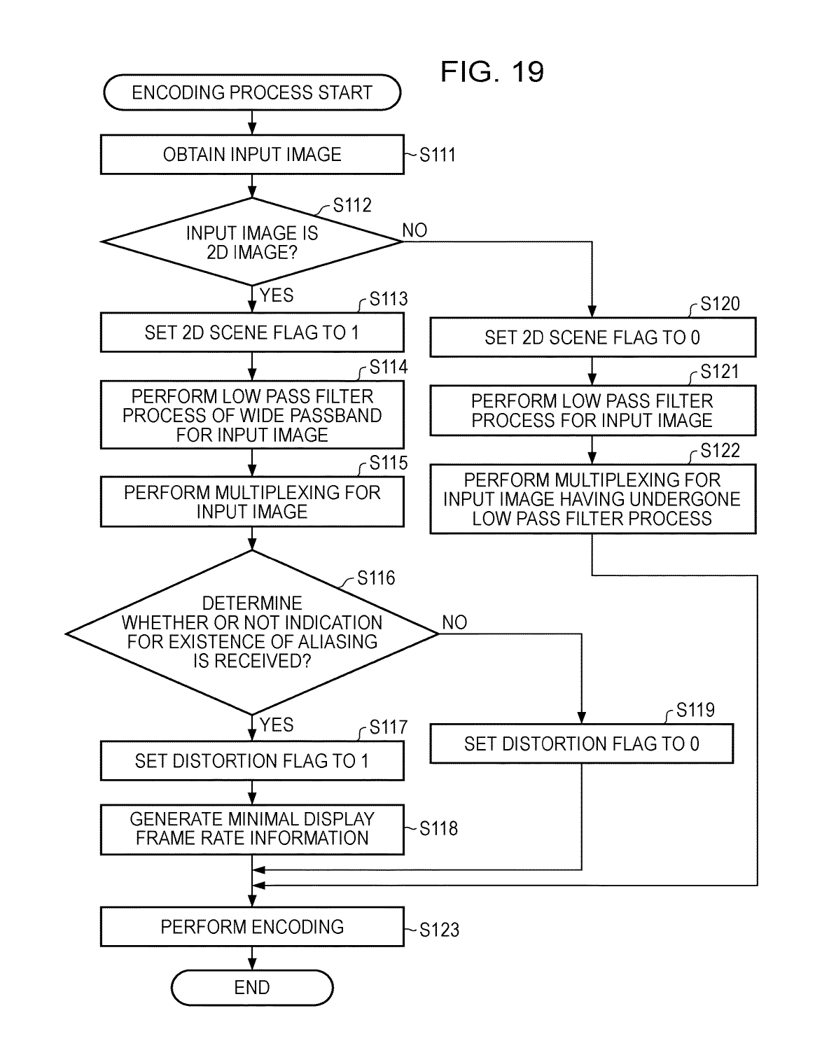

FIG. 19 is a flowchart illustrating an encoding process performed by the encoding device 151 of the image processing system 150 in FIG. 17. The encoding process starts, for example, when one bit stream including 2D images and 3D images is input to the encoding device 51.

The processes in steps S111 to S113 in FIG. 19 are the same as the processes in steps S11 to S13 in FIG. 12, the processes in steps S120 to S122 are the same as the processes in steps S15 to S17 in FIG. 12, and thus the description thereof will be omitted.

After the process in step S113, in step S114, the image multiplexing unit 161 performs, for the input image, a low pass filter process having a wider passband than a low pass filter process performed in step S121, by using a filter coefficient different from a filter coefficient for the low pass filter process performed in step S121.

In step S115, the image multiplexing unit 161 performs multiplexing similar to the multiplexing performed by the image multiplexing unit 21 in FIG. 1, for an input image obtained as a result of the low pass filter process in step S114. The image multiplexing unit 161 supplies a multiplex image obtained as a result of the multiplexing to the image encoding unit 162.

In step S116, the adding unit 163 determines whether or not an indication for existence of aliasing is received from a user. If it is determined that the indication for existence of aliasing is received in step S116, in step S117, the adding unit 163 sets the distortion flag to 1, and supplies the distortion flag to the image encoding unit 162.

In step S118, the adding unit 163 generates minimum display frame rate information in response to the indication from the user, and supplies the minimum display frame rate information to the image encoding unit 162.

On the other hand, if it is determined that the indication for existence of aliasing is not received from the user in step S116, that is, an indication for absence of aliasing is received, in step S188, the adding unit 163 sets the distortion flag to 0, and supplies the distortion flag to the image encoding unit 162.

In step S123, after the process in step S118, S119, or S122, the image encoding unit 162 performs encoding according to the AVC method using the multiplex image supplied from the image multiplexing unit 161, and the 2D scene flag supplied from the 2D scene determination unit 61. In addition, when the distortion flag is supplied from the adding unit 163, the encoding is performed using the distortion flag. When the minimum display frame rate information is supplied from the adding unit 163, the encoding is performed using the minimum display frame rate information. The processes finish.

As such, the encoding device 151 includes the distortion flag in the encoded stream. Thereby, in a case where aliasing equal to or more than a predetermined amount does not occur in the multiplex image of a 2D image, it is possible to prevent a control for the shutters of the 3D glasses from switching between a 2D image and a 3D image based on the distortion flag in the decoding device 152. As a result, in a case where aliasing equal to or more than a predetermined amount does not occur in the multiplex image of a 2D image, it is possible to prevent the control for the shutters of the 3D glasses from switching wastefully.

In addition, the encoding device 151 includes the minimum display frame rate information in the encoded stream. Thereby, in a case where a display frame rate is lower than the minimum value indicated by the minimum display frame rate information, it is possible to a control for the shutters of the 3D glasses from switching between a 2D image and a 3D image, based on the minimum display frame rate information in the decoding device 152. As a result, in a case where aliasing is not removed even if both of the left eye shutter and the right eye shutter are opened, it is possible to the control for the shutters of the 3D glasses from switching wastefully.

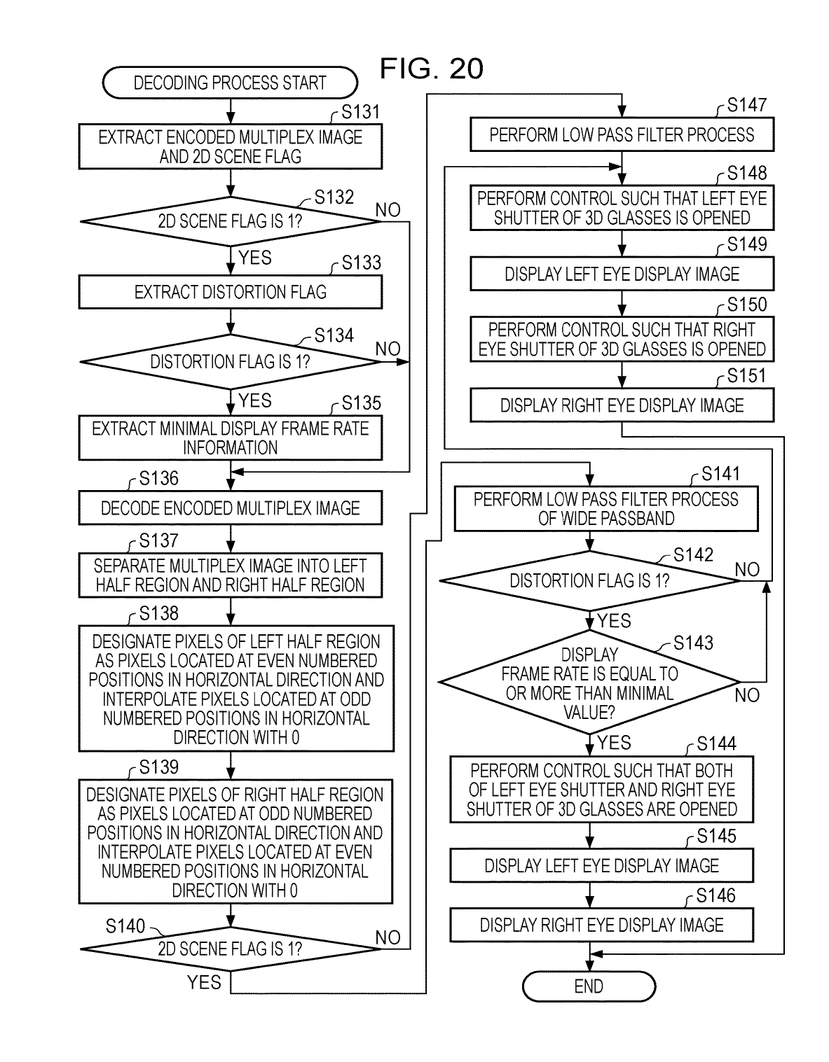

FIG. 20 is a flowchart illustrating a decoding process performed by the decoding device 152 of the image processing system 150 in FIG. 17. The decoding process is performed with picture units when the encoded stream is transmitted from the encoding device 151.

In step S131 in FIG. 20, the image decoding unit 171 of the decoding device 52 obtains the encoded stream from the encoding device 151, and extracts the encoded multiplex image, the 2D scene flag, and the like from the encoded stream. In addition, the image decoding unit 171 supplies the 2D scene flag to the image separation unit 172 and the 3D glasses control unit 173.

In step S132, the image decoding unit 171 determines whether or not the extracted 2D scene flag is 1. If it is determined that the 2D scene flag is 1 in step S132, the image decoding unit 171 extracts the distortion flag from the 2D scene information SEI of the encoded stream, and supplies the distortion flag to the determination unit 174, in step S133.

In step S134, the image decoding unit 171 determines whether or not the distortion flag is 1. If it is determined that the distortion flag is 1 in step S134, the image decoding unit 171 extracts the minimum display frame rate information from the 2D scene information SEI of the encoded stream, and supplies the minimum display frame rate to the determination unit 174, in step S135. The flow goes to step S136.

On the other hand, if it is determined that the 2D scene flag is not 1 in step S132, or if the distortion flag is not 1 in step S134, the flow goes to step S136.

The processes in steps S136 to S140 are similar to the processes in steps S32 to S36 in FIG. 13, and thus the description thereof will be omitted.

If it is determined that the 2D scene flag is 1 in step S140, the flow goes to step S141. In step S141, the image separation unit 172 performs a low pass filter process having a wider passband than a low pass filter process performed in step S147, for the image generated in step S138 and the image generated in step S139, by using a filter coefficient different from a filter coefficient for the low pass filter process performed in step S147. The image separation unit 172 supplies the image generated in step S138, having undergone the low pass filter process, to the frame sequence display control unit 73 as a left eye display image. In addition, the image separation unit 172 supplies the image generated in step S139, having undergone the low pass filter process, to the frame sequence display control unit 73 as a right eye display image. The frame sequence display control unit 73 supplies display information indicating that a display target is the left eye display image to the 3D glasses control unit 173.

In step S142, the determination unit 174 determines whether or not the distortion flag supplied from the image decoding unit 171 is 1. If it is determined that the distortion flag is 1 in step S142, the determination unit 174 determines whether or not a display frame rate in the frame sequence display control unit 73 is equal to or more than the minimum value indicated by the minimum display frame rate information supplied from the image decoding unit 171 in step S143.

If it is determined that the display frame rate is equal to or more than the minimum value in step S143, the flow goes to step S144.

The processes in steps S144 to S146 are similar to the processes in steps S37 to S39 in FIG. 13, and thus the description thereof will be omitted.

On the other hand, if it is determined that the 2D scene flag is not 1 in step S140, the flow goes to step S147. In step S147, the image separation unit 172 performs the low pass filter process for the image generated in step S138 and the image generated in step S139. The image separation unit 172 uses an image obtained as a result of performing the low pass filter process for the image generated in step S138, as a left eye display image. In addition, the image separation unit 172 uses an image obtained as a result of performing the low pass filter process for the image generated in step S139, as a right eye display image. The image separation unit 172 supplies the left eye display image and the right eye display image to the frame sequence display control unit 73, and the frame sequence display control unit 73 supplies display information indicating that a display target is the left eye display image to the 3D glasses control unit 173. The flow goes to step S148.

If it is determined that the distortion flag is not 1 in step S142, or if it is determined that the display frame rate is not equal to or more than the minimum value in step S143, the flow goes to step S148.

The processes in steps S148 to S151 are similar to the processes in steps S41 to S44 in FIG. 13, and thus the description thereof will be omitted.

As such, the decoding device 152 allows a control for the shutters of the 3D glasses to switch between a 2D image and a 3D image based on the distortion flag, only in a case where aliasing equal to or more than a predetermined amount occurs in the multiplex image. Therefore, in a case where aliasing equal to or more than a predetermined amount does not occur in the multiplex image, it is possible to prevent the control for the shutters of the 3D glasses from switching wastefully.

In addition, the decoding device 152 allows the control for the shutters of the 3D glasses to switch between a 2D image and a 3D image based on the minimum display frame rate information, only in a case where the display frame rate is greater than the minimum value indicated by the minimum display frame rate information. Therefore, in a case where aliasing is not removed even if both of the left eye shutter and the right eye shutter are opened, it is possible to the control for the shutters of the 3D glasses from switching wastefully.

Although existence or absence of aliasing is indicated by a user in the third embodiment, the existence or absence of aliasing may be automatically determined using a multiplex image. In a similar manner, the minimum display frame rate may be automatically set using the multiplex image.

In the third embodiment, in a case where an input image is a 2D image, the distortion flag is included in an encoded stream, and if the distortion flag is 1, the minimum display frame rate information is included in the encoded stream, however, the distortion flag and the minimum display frame rate information may be included at all times. In this case, the minimum display frame rate information does not have a value corresponding to an amount of aliasing occurring in a multiplex image but a fixed value. Further, in this case, either the distortion flag or the minimum display frame rate information may be included in the encoded stream.

As a multiplexing method, the over and under method may be used instead of the side by side method. In this case, pixels of an input image are decimated based on positions in the vertical direction.

Furthermore, the present disclosure may be applied to image processing systems performing encoding by methods other than the AVC method, such as the MPEG2 method.

### Description of Computer According to Embodiment

Next, the above-described series of processes may be performed by hardware or software. In a case where the series of processes is performed by software, a program constituting the software is installed in a general computer or the like.

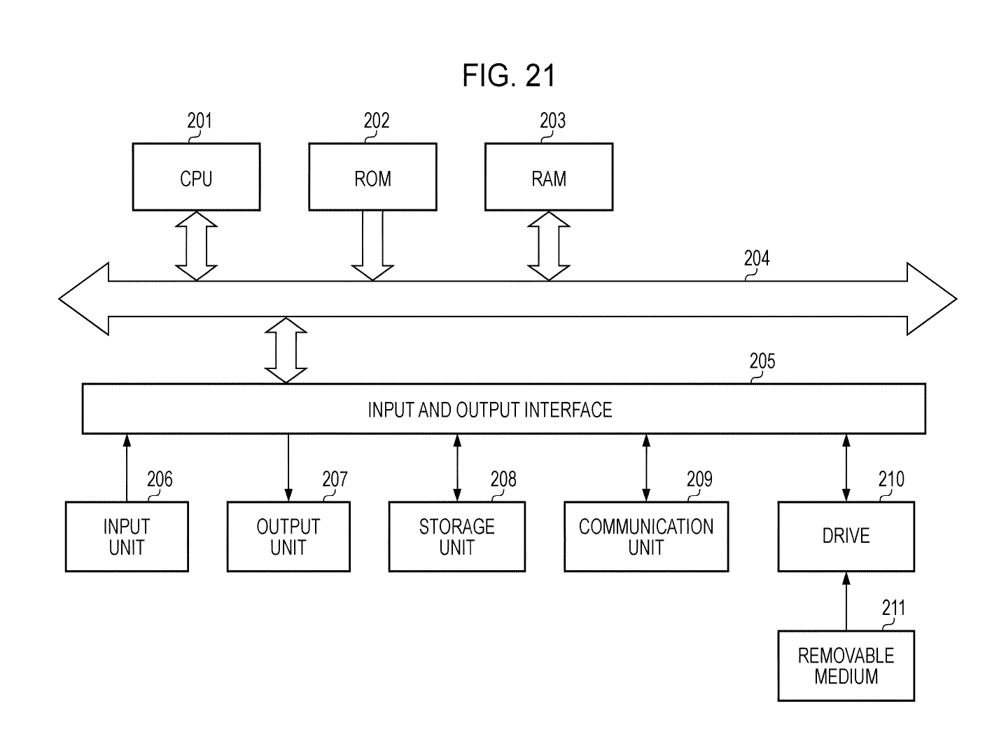

FIG. 21 shows a configuration example of a computer according to an embodiment in which a program for executing the above-described series of processes is installed.

The program may be recorded in advance in a storage unit 208 or a ROM (Read Only Memory) 202, which is a recording medium embedded in the computer.

Alternatively, the program may be stored (recorded) on a removable medium 211. The removable medium 211 may be provided as so-called package software. Here, the removable medium 211 includes, for example, a flexible disk, a CD-ROM (Compact Disc Read Only Memory), an MO (Magneto Optical) disc, a DVD (Digital Versatile Disc), a magnetic disk, a semiconductor memory, and the like.

In addition, the program may be downloaded to the computer via a communication network or a broadcasting network and installed in the embedded storage unit 208, as well as being installed in the computer from the above-described removable medium 211 via a drive 210. In other words, the program may be transmitted to the computer, for example, from a web site in a wireless manner via an artificial satellite for digital satellite broadcasting, or may be transmitted to the computer therefrom in a wired manner via a network such as LAN (Local Area Network) or the Internet.

The computer embeds a CPU (Central Processing Unit) 201 therein, and an input and output interface 205 is connected to the CPU 201 via a bus 204.

When commands are input via the input and output interface 205 by a user operating an input unit 206 or the like, the CPU 201 executes the program stored in the ROM 202 in response to the commands. Alternatively, the CPU 201 executes the program by loading the program stored in the storage unit 208 to a RAM (Random Access Memory) 203.

Thereby, the CPU 201 performs the processes according to the above-described flowcharts or the processes performed by the configurations of the above-described block diagrams. The CPU 201 enables a processed result, for example, to be output from an output unit 207, to be transmitted to a communication unit 209, to be recorded in the storage unit 208, or the like, via the input and output interface 205, as necessary.

The input unit 206 includes a keyboard, a mouse, a microphone, and the like. The output unit 207 includes an LCD (Liquid Crystal Display), a speaker, and the like.

Here, in this specification, processes which the computer performs according to the program are not necessarily performed in a time series according to procedures described as a flowchart. In other words, the processes which the computer performs according to the program may include processes performed in parallel or separately (for example, parallel processes or processes by objects).

The program may be processed by a single computer (processor) or may be processed through distribution into a plurality of computers. Moreover, the program may be transmitted to a computer in a remote location and executed.

In this specification, the system indicates the entire device configured by a plurality of devices.

The present disclosure contains subject matter related to that disclosed in Japanese Priority Patent Application JP 2010-187822 filed in the Japan Patent Office on Aug. 25, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display control device comprising:
a separation unit that separates a multiplex image obtained by multiplexing a left eye image after decimation of a predetermined phase and a right eye image after decimation of a phase reverse to the predetermined phase, into the left eye image after the decimation and the right eye image after the decimation, interpolates the predetermined phase of the left eye image after the decimation with 0, and interpolates the phase reverse to the predetermined phase of the right eye image after the decimation with 0;
a display control unit that uses an interpolated left eye image obtained by interpolating the left eye image after the decimation as a left eye display image, uses an interpolated right eye image obtained by interpolating the right eye image after the decimation as a right eye display image, and alternately displays the left eye display image and the right eye display image, in a case where an image including the left eye image and the right eye image is a 2D image; and
a glasses control unit that controls glasses such that a left eye shutter and a right eye shutter of the glasses are both opened, in a case where an image including the left eye image and the right eye image is a 2D image.

2. The display control device according to claim 1, wherein the separation unit performs a first low pass filter process for the interpolated left eye image and the interpolated right eye image in a case where an image including the left eye image and the right eye image is not a 2D image,
wherein the display control unit uses the interpolated left eye image after the first low pass filter process as the left eye display image, uses the interpolated right eye image after the first low pass filter process as the right eye display image, and alternately displays the left eye display image and the right eye display image, in a case where an image including the left eye image and the right eye image is not a 2D image, and
wherein the glasses control unit controls the glasses such that the left eye shutter is opened in a case where the left eye display image is displayed and the right eye shutter is opened in a case where the right eye display image is displayed, in a case where an image including the left eye image and the right eye image is not a 2D image.

3. The display control device according to claim 2, wherein a second low pass filter process is performed for the left eye image and the right eye image before the decimation in a case where an image including the left eye image and the right eye image is not a 2D image,
wherein a third low pass filter process having a wider passband than the second low pass filter process is performed for the left eye image and the right eye image before the decimation in a case where an image including the left eye image and the right eye image is a 2D image,
wherein the separation unit performs a fourth low pass filter process having a wider passband than the first low pass filter process for the interpolated left eye image and the interpolated right eye image in a case where an image including the left eye image and the right eye image is a 2D image, and
wherein the display control unit uses the interpolated left eye image after the fourth low pass filter process as the left eye display image, uses the interpolated right eye image after the fourth low pass filter process as the right eye display image, and alternately displays the left eye display image and the right eye display image, in a case where an image including the left eye image and the right eye image is a 2D image.

4. The display control device according to claim 3, further comprising an obtaining unit that obtains distortion information which is information indicating whether or not aliasing exists in the multiplex image,
wherein the glasses control unit controls the glasses such that both of the left eye shutter and the right eye shutter are opened in a case where an image including the left eye image and the right eye image is a 2D image and the distortion information is information indicating that the aliasing exists.

5. The display control device according to claim 1, further comprising an obtaining unit that obtains a minimum value of a display rate which is estimated to prevent aliasing from occurring in an image perceived by a user by the left eye display image and the right eye display image in a case where an image including the left eye image and the right eye image is a 2D image,
wherein the glasses control unit controls the glasses such that both of the left eye shutter and the right eye shutter are opened in a case where an image including the left eye image and the right eye image is a 2D image, and a display rate of the left eye display image and the right eye display image is equal to or greater than the minimum value.

6. The display control device according to claim 1, further comprising an obtaining unit that obtains the multiplex image, and 2D information which is information indicating whether or not an image including the left eye image and the right eye image which are sources of the multiplex image is a 2D image,
wherein the display control unit uses the interpolated left eye image as a left eye display image, uses the interpolated right eye image as a right eye display image, and alternately displays the left eye display image and the right eye display image, in a case where the 2D information is information indicating a 2D image, and
wherein the glasses control unit controls the glasses such that both of the left eye shutter and the right eye shutter are opened in a case where the 2D information is information indicating a 2D image.

7. A display control method comprising:
causing a display control device to
separate a multiplex image obtained by multiplexing a left eye image after decimation of a predetermined phase and a right eye image after decimation of a phase reverse to the predetermined phase, into the left eye image after the decimation and the right eye image after the decimation, interpolates the predetermined phase of the left eye image after the decimation with 0, and interpolates the phase reverse to the predetermined phase of the right eye image after the decimation with 0;
use an interpolated left eye image obtained by interpolating the left eye image after the decimation as a left eye display image, use an interpolated right eye image obtained by interpolating the right eye image after the decimation as a right eye display image, and alternately display the left eye display image and the right eye display image, in a case where an image including the left eye image and the right eye image is a 2D image; and
control glasses such that a left eye shutter and a right eye shutter of the glasses are both opened, in a case where an image including the left eye image and the right eye image is a 2D image.

8. An image generation device comprising:
a multiplexing unit that decimates a predetermined phase of a left eye image and a phase reverse to the predetermined phase of a right eye image and multiplexes the left eye image and the right eye image after the decimation;
a distortion related information generation unit that generates distortion related information which is information regarding aliasing in a multiplex image obtained as a result of the multiplexing performed by the multiplexing unit; and
a transmission unit that transmits the multiplex image and the distortion related information.

9. The image generation device according to claim 8, wherein the multiplexing unit performs a first low pass filter process for the left eye image and the right eye image before the decimation in a case where an image including the left eye image and the right eye image is not a 2D image.

10. The image generation device according to claim 9, wherein the multiplexing unit performs a second low pass filter process having a wider passband than the first low pass filter process for the left eye image and the right eye image before the decimation in a case where an image including the left eye image and the right eye image is a 2D image.

11. The image generation device according to claim 10, wherein the distortion related information generation unit generates distortion information which is information indicating whether or not aliasing exists in the multiplex image, as the distortion related information.

12. The image generation device according to claim 8, wherein the distortion related information generation unit separates the multiplex image into the left eye image and the right eye image after the decimation, and generates, as the distortion related information, a minimum value of a display rate which is estimated to prevent aliasing from occurring in an image perceived by a user by a left eye display image, which is obtained by interpolating the predetermined phase of the left eye image after the decimation with 0, and a right eye display image, which is obtained by interpolating the phase reverse to the predetermined phase of the right eye image after the decimation with 0, in a case where an image including the left eye image and the right eye image is a 2D image.

13. The image generation device according to claim 8, further comprising a 2D information generation unit that generates 2D information which is information indicating whether or not an image including the left eye image and the right eye image which are sources of the multiplex image is a 2D image.

14. An image generation method comprising:
causing an image generation device to
decimate a predetermined phase of a left eye image and a phase reverse to the predetermined phase of a right eye image, and multiplex the left eye image and the right eye image after the decimation;
generate distortion related information which is information regarding aliasing in a multiplex image obtained as a result of the multiplexing of the left eye image and the right eye image; and
transmit the multiplex image and the distortion related information.

15. A display control device comprising:
a separation unit that separates a multiplex image into a left eye image after decimation of a predetermined phase and a right eye image after decimation of a phase reverse to the predetermined phase, performs an interleave process for the left eye image after the decimation using the right eye image after the decimation, and performs an interleave process for the right eye image after the decimation using the left eye image after the decimation, in a case where an image including the left eye image and the right eye image which are sources of the multiplex image which is obtained by multiplexing the left eye image after the decimation and the right eye image after the decimation is a 2D image;
a display control unit that uses a processed left eye image obtained by performing the interleave process for the left eye image after the decimation as a left eye display image, uses a processed right eye image obtained by performing the interleave process for the right eye image after the decimation as a right eye display image, and alternately displays the left eye display image and the right eye display image, in a case where an image including the left eye image and the right eye image is a 2D image; and
a glasses control unit that controls glasses such that a left eye shutter of the glasses is opened in a case where the left eye display image is displayed and a right eye shutter of the glasses is opened in a case where the right eye display image is displayed.

16. The display control device according to claim 15, wherein the separation unit separates the multiplex image into the left eye image after the decimation and the right eye image after the decimation, interpolates the predetermined phase of the left eye image after the decimation with 0, interpolates the phase reverse to the predetermined phase of the right eye image after the decimation with 0, and performs a first low pass filter process for the left eye image and the right eye image after the interpolation, in a case where an image including the left eye image and the right eye image is not a 2D image, and
wherein the display control unit uses the left eye image after the first low pass filter process as the left eye display image, uses the right eye image after the first low pass filter process as the right eye display image, and alternately displays the left eye display image and the right eye display image, in a case where an image including the left eye image and the right eye image is not a 2D image.

17. The display control device according to claim 16, wherein a second low pass filter process is performed for the left eye image and the right eye image before the decimation in a case where an image including the left eye image and the right eye image is not a 2D image,
wherein a third low pass filter process having a wider passband than the second low pass filter process is performed for the left eye image and the right eye image before the decimation in a case where an image including the left eye image and the right eye image is a 2D image,
wherein the separation unit performs a fourth low pass filter process having a wider passband than the first low pass filter process for the processed left eye image and the processed right eye image in a case where an image including the left eye image and the right eye image is a 2D image, and
wherein the display control unit uses the processed left eye image after the fourth low pass filter process as the left eye display image, uses the processed right eye image after the fourth low pass filter process as the right eye display image, and alternately displays the left eye display image and the right eye display image, in a case where an image including the left eye image and the right eye image is a 2D image.

18. The display control unit according to claim 15, further comprising an obtaining unit that obtains the multiplex image, and 2D information which is information indicating whether or not an image including the left eye image and the right eye image which are sources of the multiplex image is a 2D image,
wherein the separation unit separates the multiplex image into a left eye image after the decimation and a right eye image after the decimation, performs an interleave process for the left eye image after the decimation using the right eye image after the decimation, and performs an interleave process for the right eye image after the decimation using the left eye image after the decimation, in a case where the 2D information is information indicating a 2D image, and
wherein the display control unit uses the processed left eye image as a left eye display image, uses the processed right eye image as a right eye display image, and alternately displays the left eye display image and the right eye display image, in a case where the 2D information is information indicating a 2D image.

19. A display control method comprising:
causing a display control device to
separate a multiplex image into a left eye image after decimation of a predetermined phase and a right eye image after decimation of a phase reverse to the predetermined phase, perform an interleave process for the left eye image after the decimation using the right eye image after the decimation, and perform an interleave process for the right eye image after the decimation using the left eye image after the decimation, in a case where an image including the left eye image and the right eye image which are sources of the multiplex image which is obtained by multiplexing the left eye image after the decimation and the right eye image after the decimation is a 2D image;
use a processed left eye image obtained by performing the interleave process for the left eye image after the decimation as a left eye display image, use a processed right eye image obtained by performing the interleave process for the right eye image after the decimation as a right eye display image, and alternately display the left eye display image and the right eye display image in a case where an image including the left eye image and the right eye image is a 2D image; and
control glasses such that a left eye shutter of the glasses is opened in a case where the left eye display image is displayed and a right eye shutter of the glasses is opened in a case where the right eye display image is displayed.
